(19) United States
(12) Patent Application Publication
(10) Pub. No.: US 2009/0185727 A1
(43) Pub. Date: Jul. 23, 2009

(54) Photo Pod Imaging Portal

(75) Inventors: James G. Beckmann, Las Vegas, NV (US); Jimmy John Stouffer, Steamboat Springs, CO (US)

Correspondence Address: LAW OFFICES OF BRIAN S STEINBERGER, 101 BREVARD AVENUE, COCOA, FL, 32922, US

(73) Assignee: IMAGE QUEST WORLDWIDE, INC., Las Vegas, NV (US)

(21) Appl. No.: 12/138,849

(22) Filed: Jun. 13, 2008

Related U.S. Application Data
(60) Provisional application No. 61/022,729, filed on Jan. 22, 2008.

(51) Int. Cl. G06K 9/00

(52) U.S. Cl. 382/128

(57) ABSTRACT

Methods, apparatus, devices and systems of full body imaging of a patient to diagnose and examine all front, sides, and rear surfaces of the patient. A single vertical stack tower of digital cameras located in an enclosed booth/kiosk can selectively take pictures of the front, left side, rear, and right sides of the patient. Another version has two vertical stacks of digital cameras facing the first vertical stack. Software and computers can automatically gather patient information, take pictures, compile and process the pictures, and allow for customized viewing of the pictures. The methods and systems have application for examining skin features for medical applications and law enforcement.

This invention claims the benefit of priority to U.S. Provisional Patent Application No. 61/022,729 filed Jan. 22, 2008.

### FIELD OF INVENTION

This invention relates to full body imaging, and in particular to apparatus, devices, systems and methods of using multiple cameras for taking digital pictures of surface areas of a human body to create a sequenced and comprehensive set of pictures of the entire human body, so that healthcare providers such as dermatologists can screen patients for skin changes and moles, as well as to map and assess those changes, as well as be used in other applications such as identification of persons for law enforcement, and the like.

### BACKGROUND AND PRIOR ART

The examination of the skin surfaces of the human body is extremely important to diagnose skin diseases, such as melanomas and other types of skin cancers. Early detection of problem areas is key since immediate surgical removal of a problem area that has not spread can have a very good chance of complete recovery. Obviously waiting to long to do the check, and/or not fully analyzing the surface areas can result in delays that can be deadly to the patient.

A general popular technique is to have the healthcare professional such as a dermatologist visually check the skin of the patient with their eyes and sometimes with a magnifier to see if there are skin discolorations, moles, pigments and any other types of deviations that are suspect. After a suspect target is identified, the professional will then examine the area with greater selectivity such as taking a biopsy for testing and the like. Clearly, there are inherent problems to this visual inspection technique.

Relying on the eyes of the professional is not an exact science and requires the professional to be diligent to check all skin areas, as well as make critical choices to determine the suspect areas. In addition, such visual inspections do not allow for the professional to compare previous inspections of the skin surfaces with the present ones. Thus, visual inspection although popular can often result in missing problem areas until it is too late.

Healthcare professionals also request the patient to check their skin surfaces directly and/or with someone else. However, patients and their helpers are not trained to adequately determine a suspect area. Also, such persons will not fully examine all skin surface areas. Additionally, patients and their helper cannot compare the skin surfaces to previously viewed examinations, since no records are generally kept.

The use of taking single pictures by a handheld camera is currently being done by some professionals and their patients. However, a single picture does not provide an adequate record of all skin surfaces of the human body. Additionally, it is near impossible for the healthcare provider and the patient to be able to use a single handheld camera to take enough pictures. Still furthermore, a handheld camera is difficult to use to take pictures of the entire body surface of a patient. Additionally, single photograph pictures taken at different times are difficult and often useless for comparison purposes with one another. For example, using different cameras at the different times, using different types of film, taking the pictures under different light conditions, not capturing identical camera shots will result in poor diagnostics.

Various patents and published patent applications have been proposed in related areas. See for example, U.S. Patent Publications: 2007/0073113 to Squilla; 2005/0195316 to Kollias; 2005/0119551 to Maschke; 2004/0146290 to Kollias; 2004/0125996 to Eddowes; 2004/0076414 to Inage; 2003/0045916 to Anderson; and 2001/0011262 to Hoyt. See for example, U.S. patents: U.S. Pat. No. 7,020,390 to Maeda et al.; U.S. Pat. No. 6,961,517 to Merola et al.; U.S. Pat. No. 6,915,071 to Maekawa et al.; U.S. Pat. No. 6,792,137 to Kenet; U.S. Pat. No. 6,429,8892 to Parker; U.S. Pat. No. 6,369,908 to Frey et al.; U.S. Pat. No. 6,317,560 to Kawabata; and U.S. Pat. No. 6,085,195 to Hoyt. However, none of the cited references individually or together solve all the problems with the prior art described above.

Thus, the need exists for solutions to the above problems with the prior art.

### SUMMARY OF THE INVENTION

A primary objective of the present invention is to provide an apparatus, devices, systems and methods of using multiple cameras to simultaneously capture digital pictures of all surface areas of a human body in order to create a sequenced and comprehensive set of pictures of the entire human body, so that healthcare providers such as dermatologists can screen patients for skin changes and moles, and for use with law enforcement identification, as well as to map and assess those changes.

A secondary objective of the present invention is to provide an apparatus, devices, systems and methods of using multiple cameras for taking digital pictures of all surface areas of a human body in a single private enclosure at one time so that all suspect skin conditions can be uniformly examined, as well as with law enforcement applications.

A third objective of the present invention is to provide an apparatus, devices, systems and methods of using multiple cameras for taking digital pictures of all surface areas of a human body to create a sequenced and comprehensive set of pictures of the entire human body, so that healthcare providers such as dermatologists can screen patients for skin changes and moles, as well as to map and assess those changes.

A fourth objective of the present invention is to provide for apparatus, devices, systems and methods of using multiple cameras for taking digital pictures of all surface areas of a human body so that computers and software can analyze all skin conditions of the patient from both a macro point of view as well as down to the centimeter or less to identify inconsistencies, risks or other anomalies that the user wishes to locate.

A preferred method of imaging all skin surfaces of a body, can include the steps of gathering and entering identification information on a patient into a computer, capturing front, left and right sides and back pictures of the patient with multiple cameras, gathering the pictures into digital images, and viewing organized and selected versions of the digital images.

The gathering and entering identification information can include the steps of inputting name, height, weight, gender and patient social security number and password.

The capturing step can include the steps of capturing front pictures of the patient with a vertical stack of digital cameras, capturing left side pictures of the patient with the digital cameras, capturing back pictures of the patient with the digital cameras, and capturing right side pictures of the patient with the digital cameras.

The gathering the pictures step can include the steps of compiling the images, processing the images, creating object VR images, creating a set of stereo images, sending image session to server or a computer, writing a CD or a DVD of the images or storing the images on a computer or other types of electronic or print media, and readying for another patient.

The viewing step can include the step of organizing digital film strips for each pose, and zooming and scrolling portions of the images.

The capturing of the images can include the following steps.

Front view with thumbs forward;

Front view with palms facing forward;

Front view with palms facing back;

Front view under breasts;

Front view of inside of right thigh; and

Front view of inside of left thigh;

Left view with left arm down;

Left view with left arm up;

Back view with arms and legs down;

Back view with arms up;

Back view with left foot up;

Back view with right foot up.

Right view with right arm down; and

Right view with right arm up.

A preferred embodiment of a total body imaging system can include a booth enclosure having an entranceway, and a privacy area, and a vertical stack of digital cameras, such as two to six cameras, wherein front, left side, right side and rear of a patient is imaged with selected cameras or all cameras.

The enclosure can include walls that are slideable with one another so that the enclosure is collapsible or a curtain system.

The system can have a touch screen computer for allowing an operator to enter patient data, take digital pictures, and compile and process the pictures for viewing selected pictures.

The vertical stack of cameras can include a left angled light panel on a left side of the vertical stack of cameras, and a right angled light panel on a right side of the vertical stack of cameras or other types of lighting.

The system can have a left top strobe mounted on top of the left angled light panel, left bottom strobe mounted on a bottom of the left angled light panel, right top strobe mounted on top of the right angled light panel, and right bottom strobe mounted on bottom of the right angled light panel or incorporated internal or external lighting.

A method of imaging all skin surfaces of a body, can include the steps of gathering and entering identification information on a patient into a computer, capturing front, left and right sides and back pictures of the patient with multiple cameras, gathering the pictures into digital images, and viewing organized and selected versions of the digital images. The gathering and entering identification information step can include inputting name, height, weight, gender and patient social security number and password.

The capturing step can include the steps of capturing front pictures of the patient with a vertical stack of digital cameras, capturing left side pictures of the patient with the digital cameras, capturing back pictures of the patient with the digital cameras, and capturing right side pictures of the patient with the digital cameras.

The gathering the pictures step can include the steps of Compiling the images, Processing the images, Creating object VR images, Sending image session to server, Writing a CD or a DVD of the images, and Readying for another patient.

The viewing step can include the steps of organizing digital film strips for each pose, and Zooming and scrolling portions of the images.

The capturing of the images can include capturing pictures of front view with thumbs forward, front view with palms facing forward, front view with palms facing back, front view under breasts, front view of inside of right thigh, and front view of inside of left thigh. Further views can include capturing pictures of left view with left arm down and left view with left arm up. Further views can include capturing pictures of back view with arms and legs down, back view with arms up, back view with left foot up, and back view with right foot up. Further views can include capturing pictures of right view with right arm down and right view with right arm up.

The capturing step can include the steps of providing at least five digital cameras as a single stack of the cameras, click activating all the cameras in the single stack simultaneously so that a complete front view of the patient is taken with the single stack of cameras, and repeating the click activating step so that all orthogonal planar views of the patient are taken with the single stack of cameras from a total of only four click activations of the stacked cameras. The capturing step can include orienting the patient to physically move from the front view to the left side view to the back view to the right side view in front of the single stack of the digital cameras so that a total of four click activations will result in at least twenty pictures being taken.

The method can include the steps of providing a second stack of at least five digital cameras, that are facing the first stack of the at least five digital cameras, click activating all the cameras in the first stack of digital cameras simultaneously so that the front view of the patient is taken, click activating all the cameras in the second stack of digital cameras so that the back view of the patient is taken, and repeating the above so that all orthogonal planar views of the patient are taken with only two click activations of the first and second stacked cameras. This can also include the step of orienting the patient to physically turn perpendicular in front of the first and she second stacks of digital cameras so that a total of two click activations will result in at least twenty pictures being taken.

A total body imaging system can include a mobile booth enclosure having an entranceway, and side walls and rear wall closing the enclosure or a privacy curtain, and a vertical stack of digital cameras, wherein front, left side, right side and rear of a patient is imaged with selected cameras, the vertical stack of cameras including between two to six cameras in the vertical stack.

The enclosure can include walls that are slideable with one another so that the enclosure is collapsible. The system can include a touch screen computer for allowing an operator to enter patient data, take digital pictures, and compile and process the pictures for viewing selected pictures.

The single tower can have at least five digital cameras, and a single control for simultaneously activating the at least five digital cameras so that physically turning the patient from the front to the left side to rear and to the right allows for all orthogonal planar views of patient to be imaged with only four activations of the single control.

The system can have a first single tower of at least five digital cameras, a second single tower of at least five digital cameras, the second single tower facing the first single tower, and a control for simultaneously activating all the cameras in the first single tower and all the cameras in the second single tower so that physically turning the patient in a perpendicular direction allows for all orthogonal planar views of patient to be imaged with only two activations of the control.

The vertical stack of digital cameras can include a left angled light panel on a left side of the vertical stack of cameras, and a right angled light panel on a right side of the vertical stack of cameras.

The system can have a left top strobe mounted on top of the left angled light panel, a left bottom strobe mounted on a bottom of the left angled light panel, a right top strobe mounted on top of the right angled light panel, and a right bottom strobe mounted on bottom of the right angled light panel.

Further objects and advantages of this invention will be apparent from the following detailed description of the presently preferred embodiments which are illustrated schematically in the accompanying drawings.

### BRIEF DESCRIPTION OF THE FIGURES

FIG. 1A is a top view foot print of the kiosk/booth enclosure.

FIG. 1B is a front view of the kiosk/booth enclosure with patient entrance.

FIG. 2A is a top view of the enclosure fully assembled.

FIG. 2B is another top view of the enclosure with or without the privacy curtain, with the walls, sliding toward one another.

FIG. 2C is a collapsed view of the enclosure with or without the privacy curtain, with the walls slid toward one another.

FIG. 3 is a preferred embodiment of the kiosk/booth enclosure fully assembled.

FIG. 4 is a front view of the operator side controls for the kiosk/booth enclosure.

FIG. 5 shows an overview of the power runs for the equipment of the enclosure.

FIG. 6 shows an overview of the camera tower and lighting used with the enclosure.

FIG. 7 shows the main flowchart four steps of gathering patient info, capturing pictures, gathering images from the pictures and viewing the images.

FIG. 7A lists the substeps of the first main step of gathering patient information.

FIG. 7B lists the substeps of the second main step of capturing the pictures by selecting photo positions.

FIG. 7C lists the substeps of the third main step of gathering the images.

FIG. 7D lists the substeps of the fourth main step of viewing the images.

FIG. 8 is a flowchart for imaging pictures for new patient or reviewing images of archived patients.

FIGS. 9A and 9B show the flowchart of the operator view steps.

FIG. 10 is a flowchart of the patient view steps.

FIGS. 11A, 11B, 11C, 11D, 11E, and 11F show the screen shots for the operator.

FIGS. 12A, 12B, 12C, 12D, 12E, 12F, 12G and 12H shows the screen shots for taking different image sets of the patient.

FIGS. 13A, 13B, 13C, 13D, 13E, 13F, 13G, 13H, 13I, 13J, 13K, 13L, 13M, and 13N show image sets with different vertical cameras being used in each set, for large PT.

FIGS. 14A, 14B, 14C, 14D, 14E, 14F, 14G, 14H, 14I, 14J, 14K and 14L show 12 image sets with different vertical cameras being used in each set, for smaller PT.

FIG. 15 shows a perspective view of another kiosk/booth enclosure with single column of fixed cameras for where the patient physically rotates to different positions.

FIG. 15A shows the kiosk/booth of FIG. 15 without the current and curtain rod folded.

FIG. 16 shows an operator station for operating the cameras and lights of FIGS. 15-15A.

FIG. 17 shows a perspective view of another kiosk/booth enclosure with two columns of fixed cameras for taking pictures of a patient.

FIG. 17A is a top view of the kiosk/booth of FIG. 17.

FIG. 18 is a partial view of a rotatable pod stand.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

A list of components will now be described.
1. Kiosk/Booth
10. Front Wall Assembly
12. Hinged Door
16. Front Left Corner Partition
17. Opening for Cameras
18. Front Right Corner Partition
20. Rear Wall Assembly
22. side inner wall
26. back wall
28. side inner wall
30. Privacy curtain
100. Operator Station
110. Camera Tower with Stacked Cameras
120. work space counter top
130 cable gutter
132 AC power
134. touch screen controller
136. key board
138. CD/DVD printer/recorder
140. thermal printer
142. CPU
144. software
146. media storage
148. multi port USB connection, DC power supply
150. privacy cam viewer
152, 154. blinders
162. plastic diffused light panel
164. strobe light unit pair or a florescent lighting system
172. plastic diffused light panel
174. strobe light unit pair or a florescent lighting system
180. main power supply
182. 2—110 v AC for lights
184. 2—110 v AC for lights
186. 2—110 v AC power strips under the counter top 120
200. main flowchart of four steps
210. Step 1, gathering patient info.
220. Step 2, capturing pictures.
230. Step 3, gathering images from the pictures.
240. Step 4, viewing the images.
300. Flowchart of imaging pictures
400. Flowchart of operator view steps
500 Flow chart of patient view steps
600. Fixed kiosk/booth with single stack of cameras
610. first angled wall
615. light panel on first angled wall
620. second angled wall
625. light panel on second angled wall
630. middle tower
640. stacked cameras in tower
650. support brace
660. foldable curtain rod
665. curtain
670. wheels
680. operator station
682. monitor
684. keyboard
686. printer
688. cpu (computer)
692. table top
694. support arms
696. floor stand
698. wheels
700. fixed kiosk/booth with two stacked columns of cameras
710. first angled wall
715. first light panel
720. second angled wall
725. second light panel
730. third angled wall
735. third light panel
740. fourth angled wall
745. fourth light panel
750. fifth angled wall
755. fifth light panel
760. first tower
765. first column of stacked cameras
770. second column
775. second column of stacked cameras
780. wheels
800. rotatable pod
810. upper cap
820. power/communication links
830 vertical wall panel
831. support arm
832. light source
835. camera
840 vertical wall panel
841. support arm
842. light source
845. camera
850. vertical wall panel

The invention is a total body photography or a digital skin screening solution. Originally invented as an investigative tool and aid for dermatologists to mole map or digitally screen the entire body, the device has many uses outside of healthcare. The invention provides for a reliable and reproducible process to individuals at high risk for developing melanoma and other skin cancers. The device offers a proprietary solution for obtaining high-quality digital images of the entire skin surface area using multiple cameras or other imaging capture devices to create a sequenced and comprehensive set of pictures of the entire human body. A physician can use this device to screen patients for skin changes and moles, as well as to map and assess changes among other uses.

The Photo Pod Portal, is a “photographer less” kiosk firing multiple cameras at one time, sorting the images, rename the images, and archive the image set to a media of the user's choice. Our model can be used for a physician office/medical clinic setting and many other environments calling for the total body photography or digital skin screening.

The system collects multiple images from multiple cameras at the same time. The device catalogs and renames the images so that they can be compiled and viewed and documents with physician or other user comments.

The invention covers the combination of total body photography or digital skin screening with multiple cameras inside a privacy pod coupled with leveraging third party or company developed software to provide results for the user to scientifically or otherwise analyze the skin from both a macro point of view as well as down to the centimeter or less to define and identify inconsistencies, risks or other anomalies that the user wishes to locate.

The multiple cameras each simultaneously capture images from different parts of the body. Up to 100 pictures with the subject standing in up different positions, such as up to six or more positions, taking place in about 5 minutes.

The Kiosk structural components are to include:

Multiple digital cameras

Capturing multiple images at the same time

Image stitching

Multiple computer processing

Image viewing

Controlled lighting

Repeatability

Privacy for the subject

Image printing

Image archiving

Modular construction

Stainless steel exterior

Non reflective interior

Touch screen operation

Light weight and shippable

Transportable

Integrated viewing device

Integrated light dome

Audio and video instructions

Windows or Mac complaint

Network able

UV lighting enabled

Open ended video and still input

Laser Encryption

Hyppa complaint reporting

0-Scape “Foldable to a wall”

Integrated software solutions for reporting can include:

High resolution imaging

Zoom in and zoom out

Imaging sizing

High resolution printing

Cropping

Pull down dialogue boxes

Journaling

Audio and video components

Grid overlays

Diffused patient prevue

Image comparison

Remote access

Integrated training

Appendable Data archiving

Password protected image sets

Conventional Imaging format

Open end architecture for Other MFG image devices

Automated Image and File re-numbering and sequencing

Low resolution video monitoring

Side by side image comparison

Image overlay

Image date comparison

Image coordination

Image drill down

Report recalling

Remote image viewing

Remote image reporting

Data comparison

Sorting data by a verity of methods

Object VR Conversions

3-D Viewing

3-D Measuring

Plotting

Graph mapping

Global locating

Protein or other forms of injection observation and viewing

Non traditional lighting

3-D image capture

A preferred embodiment of a total body imaging system or digital skin screening, can include a booth enclosure having an entranceway, and side walls and rear wall closing or a privacy curtain the enclosure, and a vertical stack of digital cameras, such as a six or more or less cameras in the camera tower, wherein front, left side, right side and rear of a patient is imaged with selected cameras.

The enclosure can include walls that are slideable with one another so that the enclosure is collapsible.

The system can have a touch screen computer for allowing an operator to enter patient data, take digital pictures, and compile and process the pictures for viewing selected pictures.

The vertical stack of cameras can include a left angled light panel on a left side of the vertical stack of cameras, and a right angled light panel on a right side of the vertical stack of cameras.

The system can have a left top strobe mounted or fixed lighting on top of the left angled light panel, left bottom strobe or fixed lighting mounted on a bottom of the left angled light panel, right top strobe or fixed lighting mounted on top of the right angled light panel, and right bottom strobe or fixed lighting mounted on bottom of the right angled light panel.

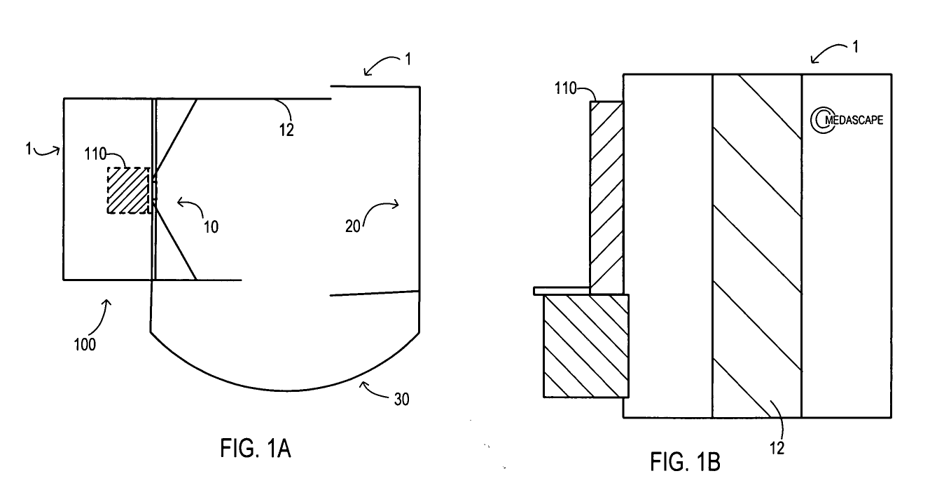

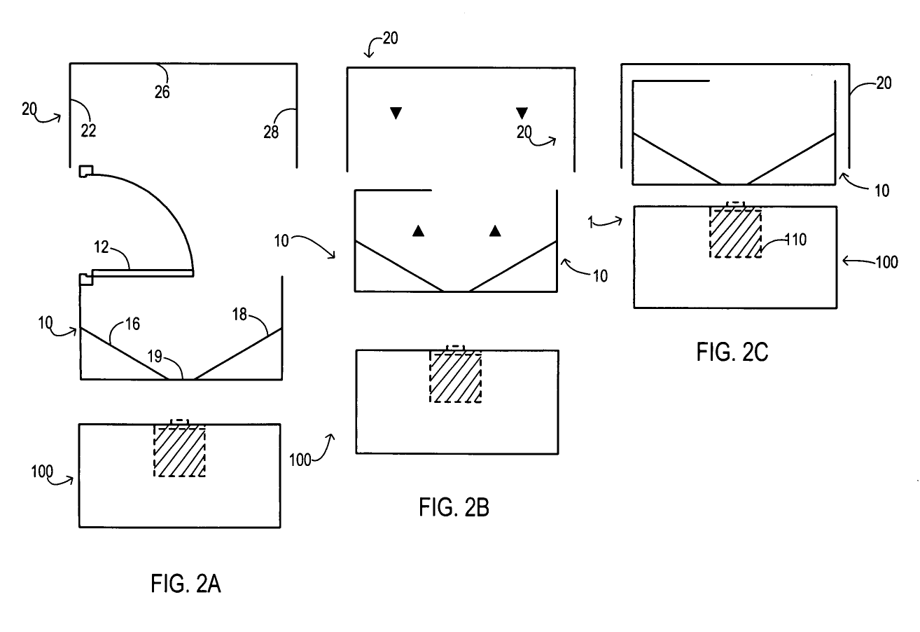

FIG. 1A is a top view foot print of the kiosk/booth enclosure 1. FIG. 1B is a front view of the kiosk/booth enclosure 1 with patient entrance 12. FIG. 2A is a top view of the enclosure 1 fully assembled. FIG. 2B is another top view of the enclosure walls or curtain of the front wall assembly 10, sliding into the rear wall assembly 20. FIG. 2C is a collapsed view of the enclosure walls or a curtain 10, 20 slid within one another, which allows for ease in transportation of the enclosure 1 as well as storage of the collapsed enclosure 1 since it takes up less than half the space as an assembled enclosure 1.

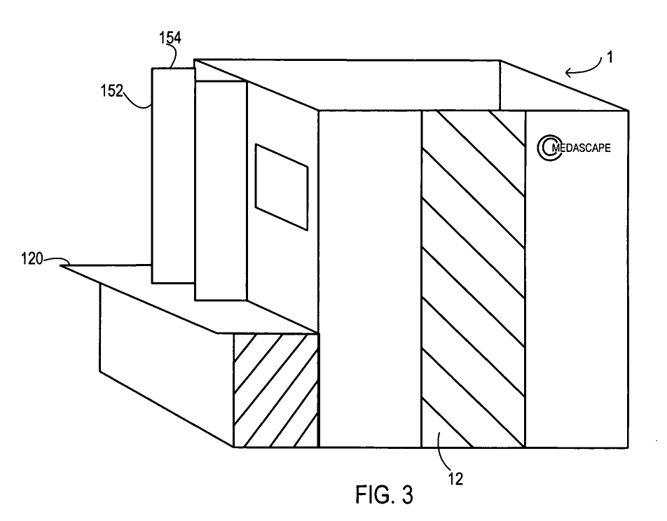

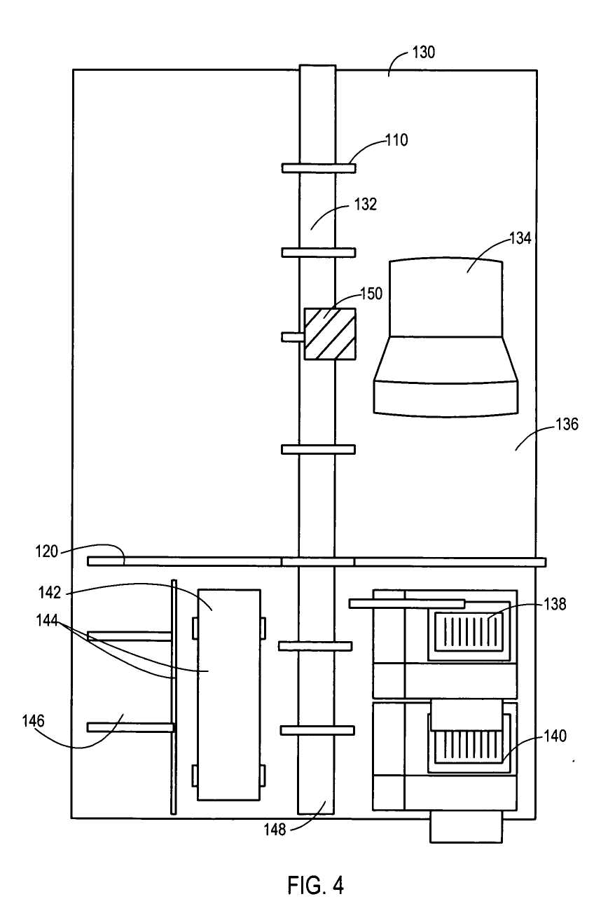

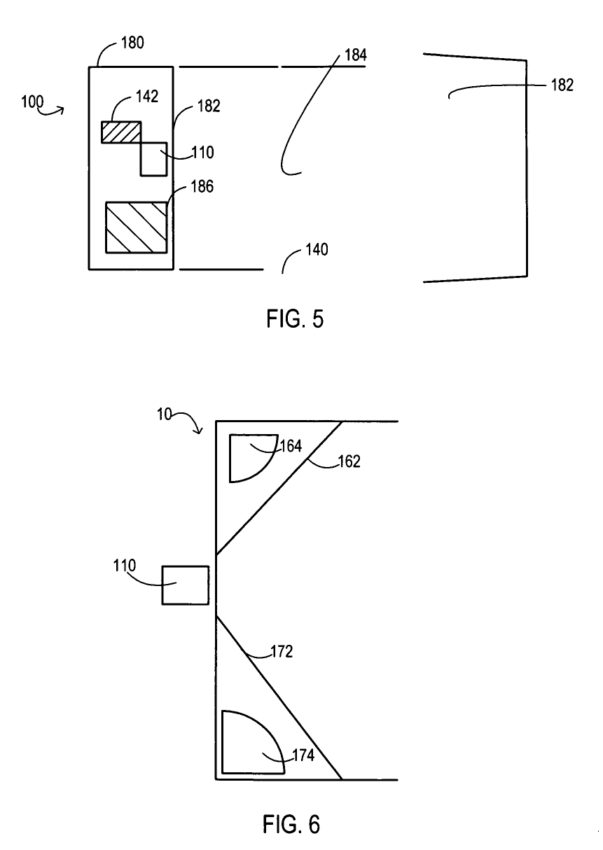

FIG. 3 is a preferred embodiment of the kiosk/booth enclosure 1 fully assembled. FIG. 4 is a front view of the operator side controls of the operator work station area 100 for the kiosk/booth enclosure 1. FIG. 5 shows an overview of the power runs for the equipment of the enclosure 1. FIG. 6 shows an overview of the camera tower 110 and lighting 162, 164, 172, 174 used with the enclosure 1.

Referring to FIGS. 1-6, the enclosure 1 can include a front wall assembly 10 having a hinged door 12, with front left corner partition 16, front right corner partition 18 and opening 17 therebetween for the cameras 110. The enclosure 1 can also include a rear wall assembly 20 having side inner wall 22, back wall 26, side inner wall 28, optional privacy curtain 30 covering a side opening between a front wall assembly 10 and rear wall assembly 20. The wall enclosure 1 can have a length of approximately 6 feet and width of approximately 4 feet and be made from separate approximately 2′ by approximately 6 feet 7 inches stainless steel metal panels.

Positioned against a face of the front wall assembly 10 can be an operator station 100 having a camera tower 110 of stacked digital cameras that is aimed through the opening 17. Each camera in the stack 110 can have a one AC power converter, with one DC power cord, one USB cable, and one flash sync cable. The operator station 100 can have a work space counter top 120 with a cable gutter 130 ending below the counter top 120, an AC power, USB, flash sync 132 mounted to the camera tower 110, a touch screen controller 134 to the right of the tower, a key board 136. A CD/DVD printer/recorder 138 and thermal printer 140 can be mounted under the counter top 120. To the left of the camera tower 110 can be a CPU 142 with an internet (web) connection, that works off the imaging solution software 144 (which is described further on). Under the counter top 120 can be a media storage 146 such as a magnetic medial storage device, and a multi port USB connection, 148 with DC power supply for a “privacy cam.”

The operator station 100 can have a main power supply 180 of two 110 V AC to power, 2—8 plug power strips, 2—110 v AC power strips 186 under the counter top 120 both for the equipment in the operator station 100, a 12 V converter to power for the camera tower 110, with two pairs of 110 v AC power 182, 184 for the lights 164, 174. Inside the front wall enclosure 10 can be angled approximately ⅛ inch plastic diffused light panels 162 in the inner corners that filter light being emitted by pairs of individual strobe units 164, 174 that are mounted on top of each other inside of those corners, so that a total of four strobe lights or fixed lighting can be used on those persons going into the enclosure 1.

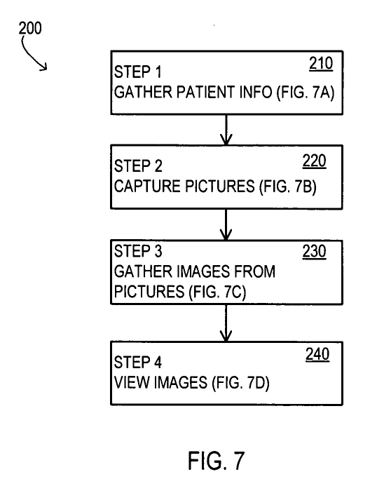

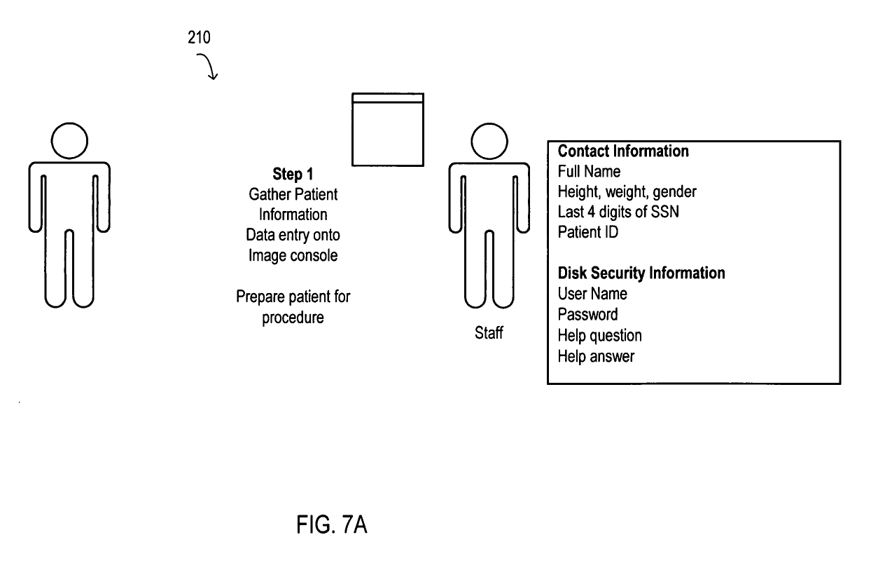

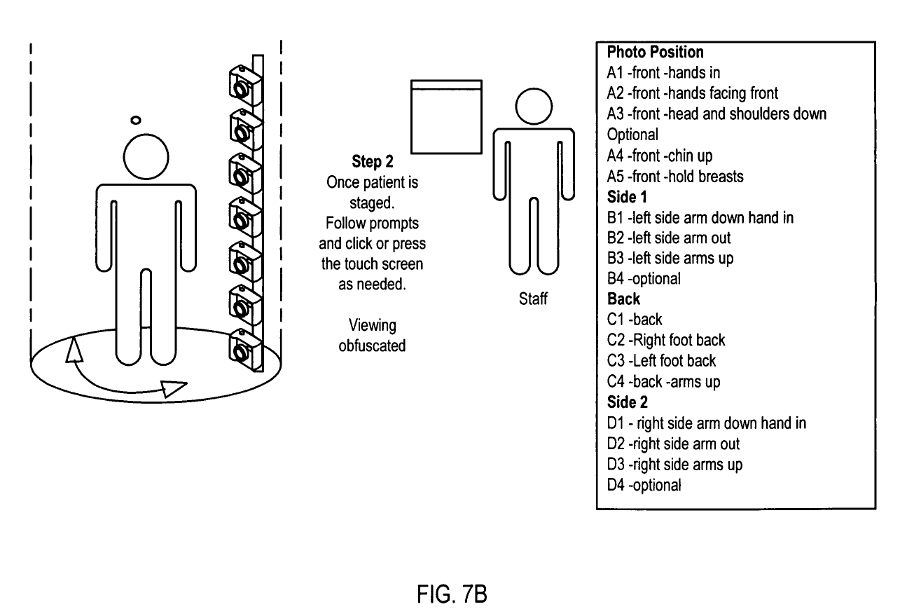

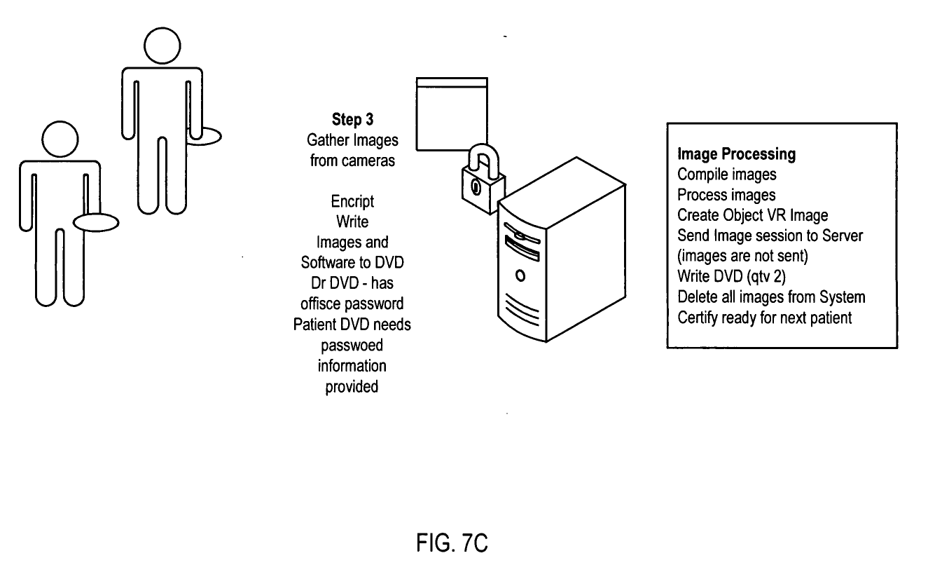

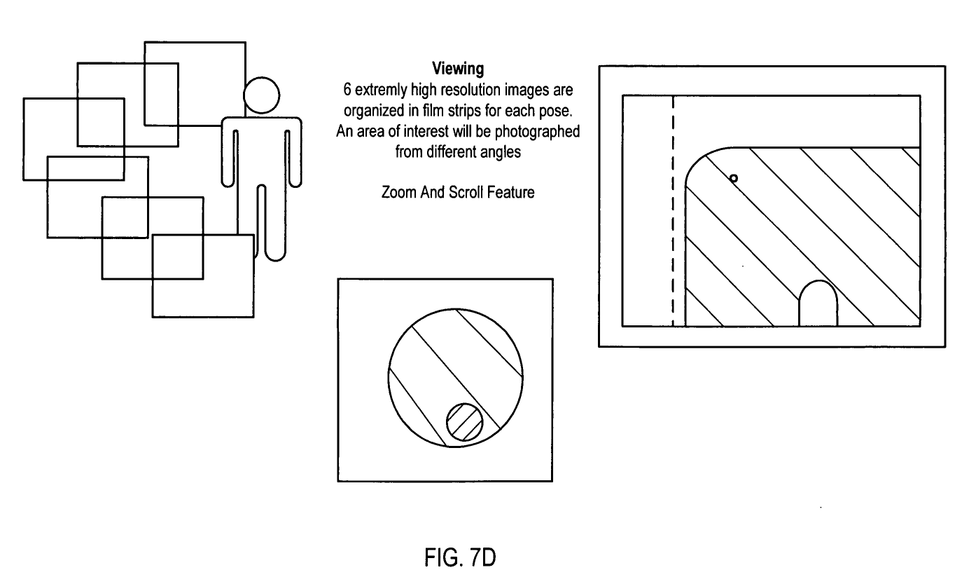

FIG. 7 shows the main flowchart 200 of the four steps of gathering patient info 210, capturing pictures 220, gathering images from the pictures 230 and viewing the images 240. FIG. 7A lists the substeps of the first main step 210 of gathering patient information. FIG. 7B lists the substeps of the second main step 220 of capturing the pictures by selecting photo positions. FIG. 7C lists the substeps of the third main step 230 of gathering the images. FIG. 7D lists the substeps of the fourth main step 240 of viewing the images.

A preferred method of imaging all skin surfaces of a body, can include the steps shown in FIGS. 7 and 7A-7D of gathering and entering identification information on a patient into a computer 210 FIG. 7A, capturing front, left and right sides and back pictures of the patient with multiple cameras 220 FIG. 7B, gathering the pictures into digital images 230 FIG. 7C, and viewing organized and selected versions of the digital images 240 FIG. 7D.

The gathering and entering identification information step 210, FIG. 7A can include the steps of inputting name, height, weight, gender and patient social security number and password.

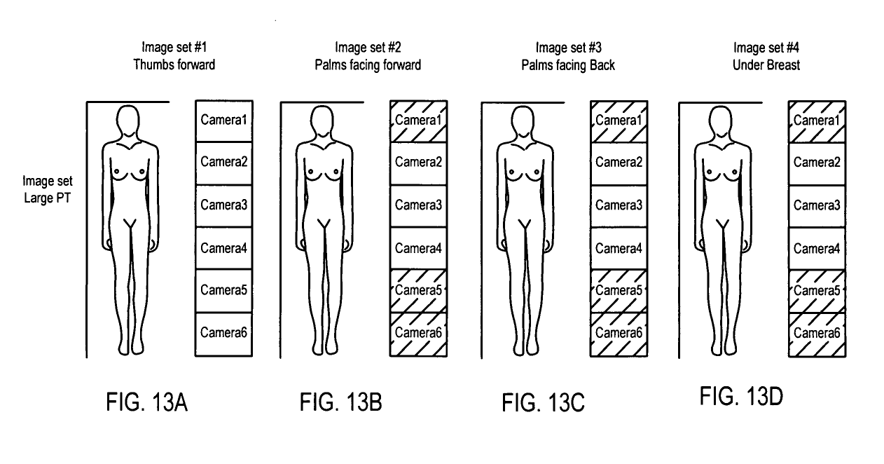

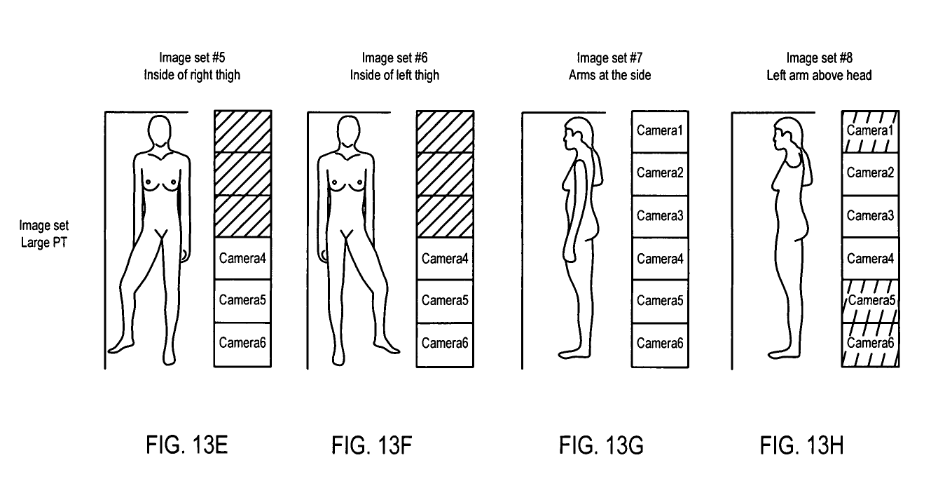

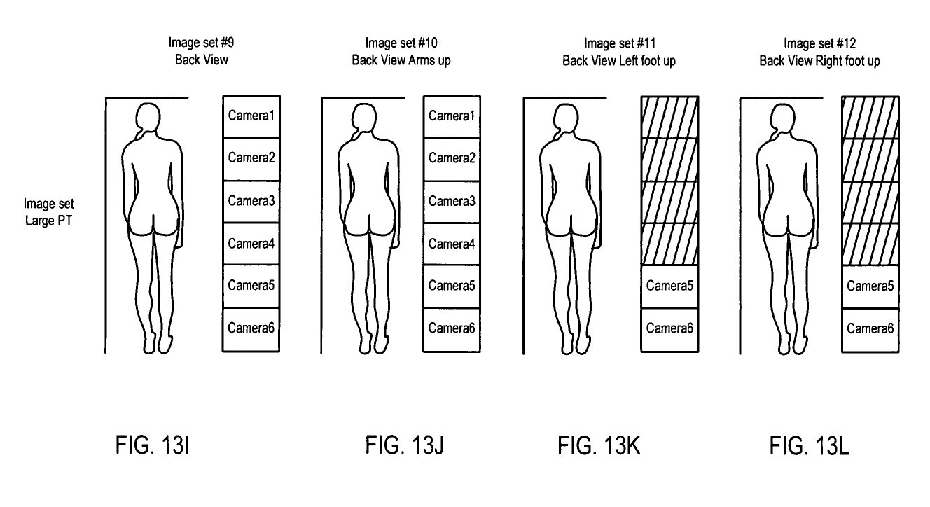

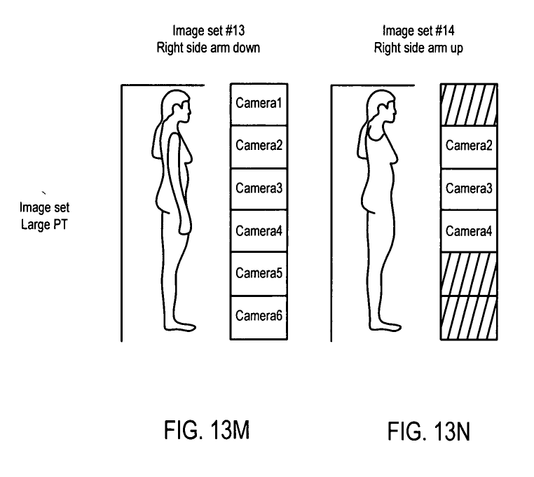

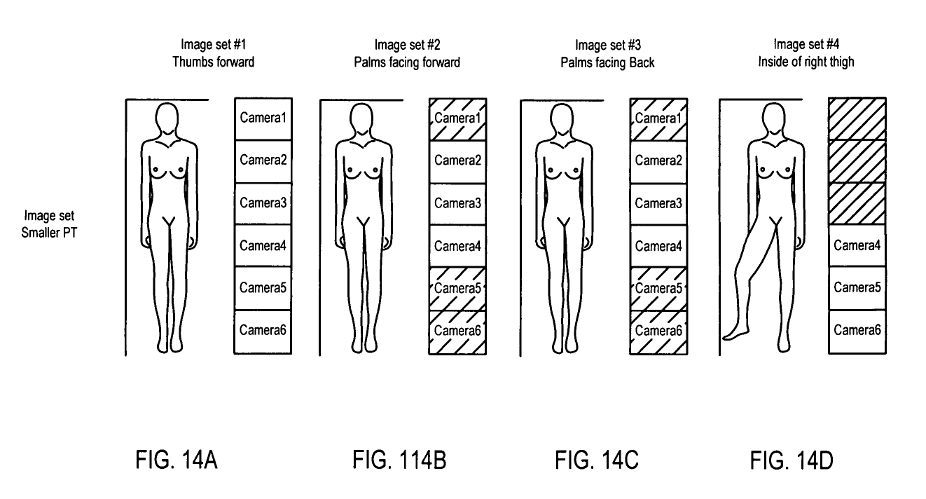

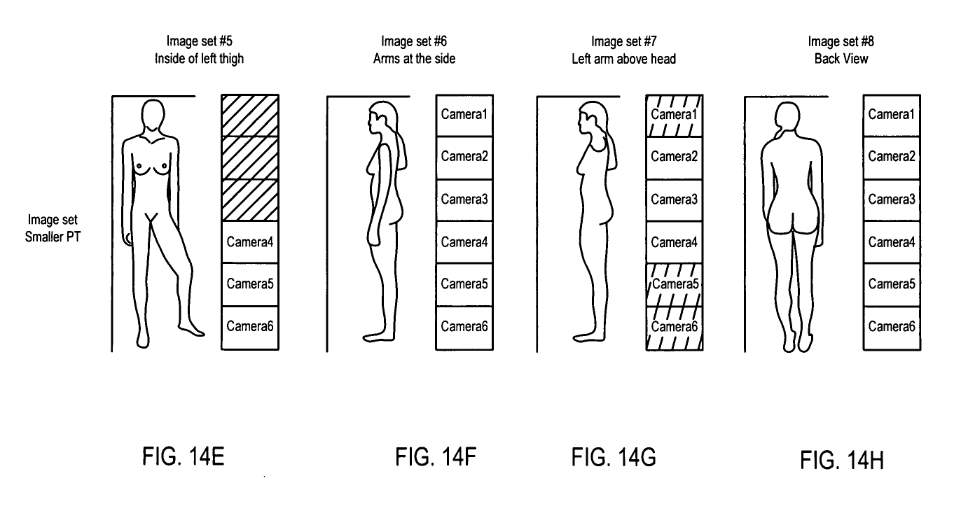

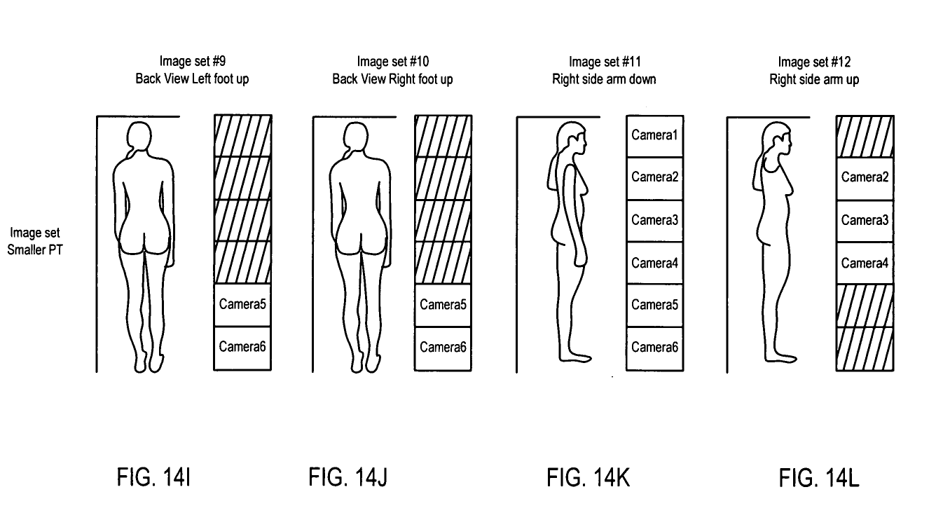

The capturing step 220, FIG. 7B can include the steps of capturing front pictures of the patient with a vertical stack of digital cameras, capturing left side pictures of the patient with the digital cameras, capturing back pictures of the patient with the digital cameras, and capturing right side pictures of the patient with the digital cameras. FIGS. 13A-14L show various images shots that can be captured.

The gathering the pictures step 230 FIG. 7C can include the steps of compiling the images, processing the images, creating object VR images, sending image session to server, writing CD or DVD or other electronic media of the images, and readying for another patient.

The viewing step 240 FIG. 7D can include the step of organizing digital film strips for each pose, and zooming and scrolling portions of the images.

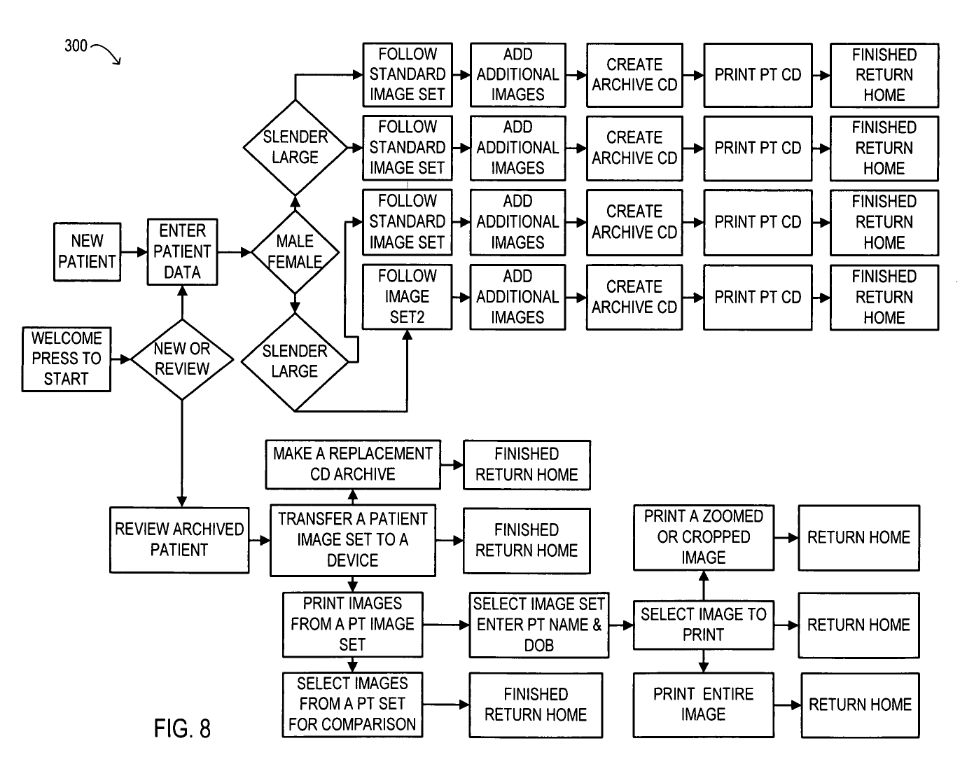

As referenced above, once the patient info has been taken (FIG. 7A), pictures have been captured (FIGS. 17B, 13A-14L), the images are gathered (FIGS. 7C and 8). FIG. 8 is a flowchart 300 for imaging pictures for new patient or reviewing images of archived patients. FIG. 8 is a flowchart of the menu steps for the entire Medascape wizard software solution. The flowchart would include all choices that the imaging technician or the person who is in charge of the “Office image archive” or a Medascape technician would have to make. The actual steps can also depend on who logs in as a member. The flowchart can include different levels of security with each different login option.

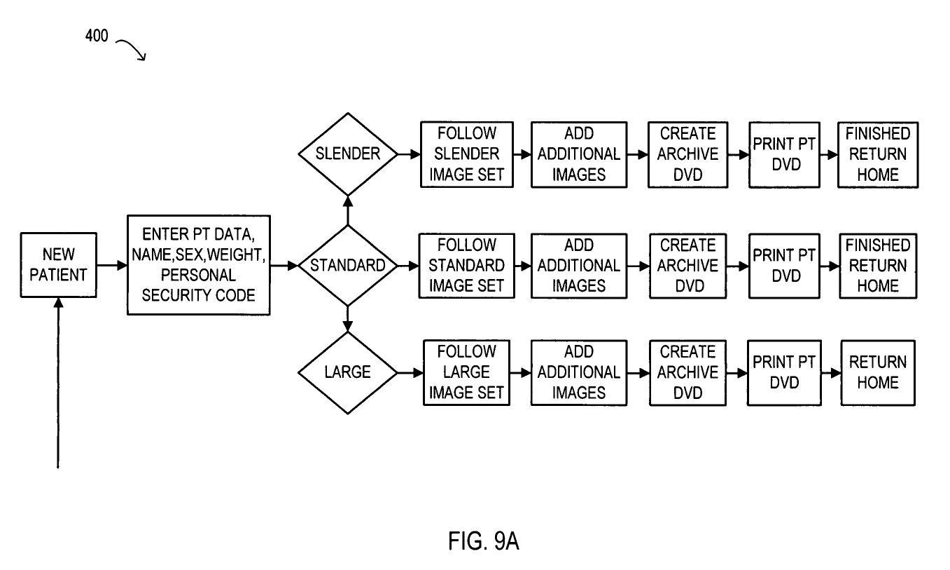

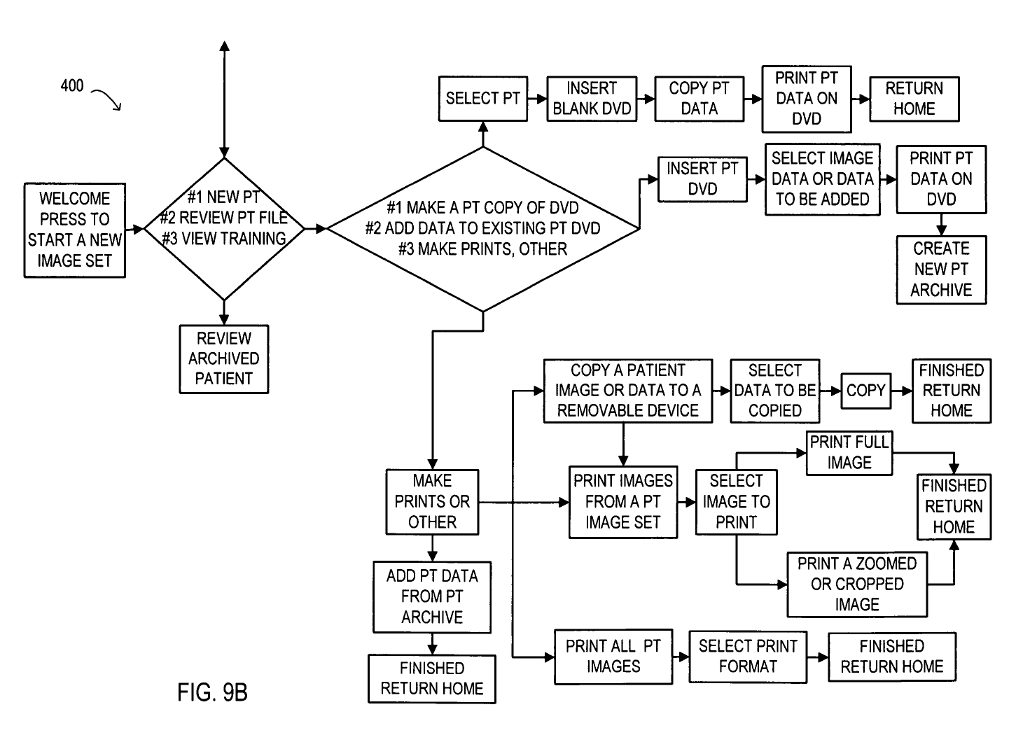

FIGS. 9a and 9b show the flowchart of the operator view steps 400 which are the details of the screen choices from above. As shown, running through the flow chart can depend on how the user is logged in.

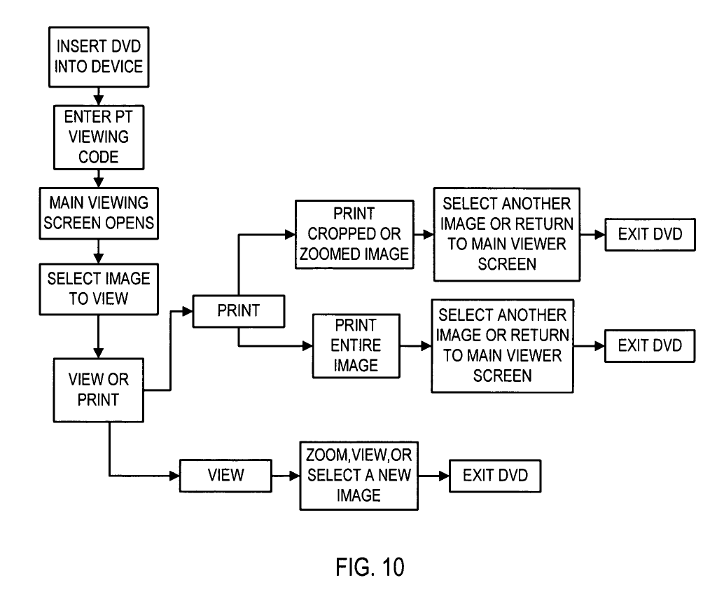

FIG. 10 is a flowchart of the patient view steps 500. FIG. 10 is the flowchart of the data flow that occurs when the patient is viewing the “patient copy” of the CD or DVD when at home or at a remote location.

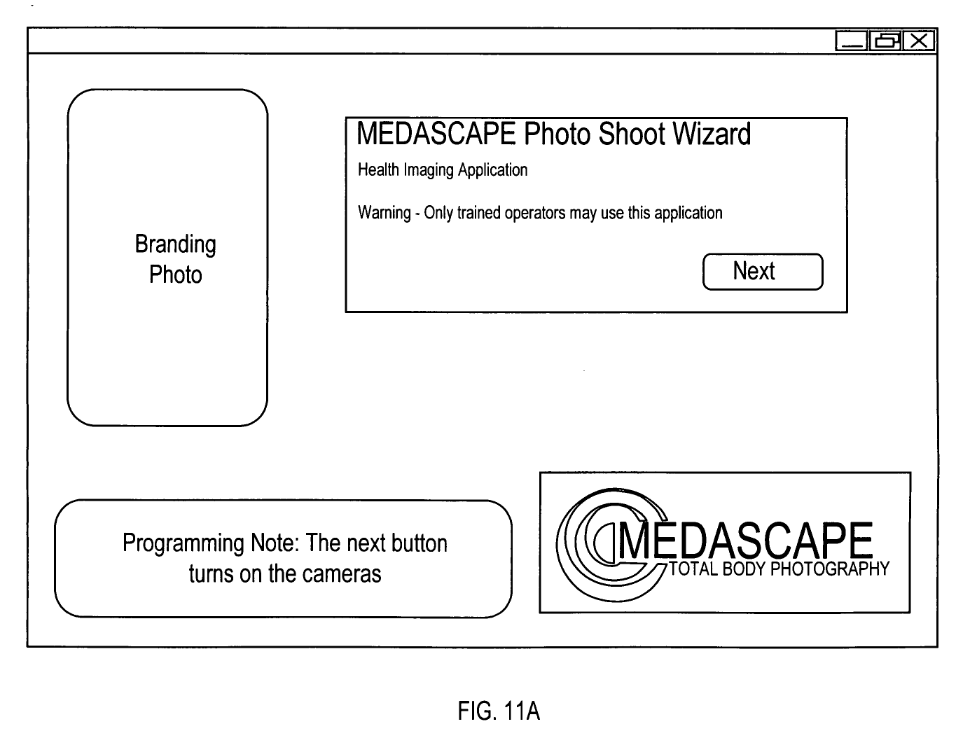

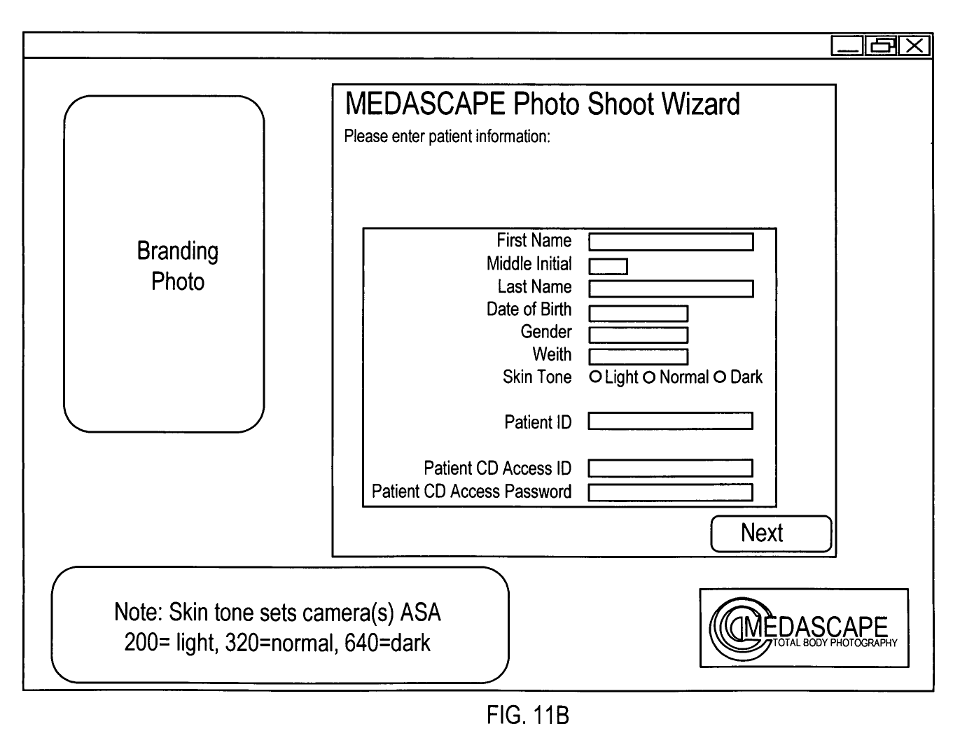

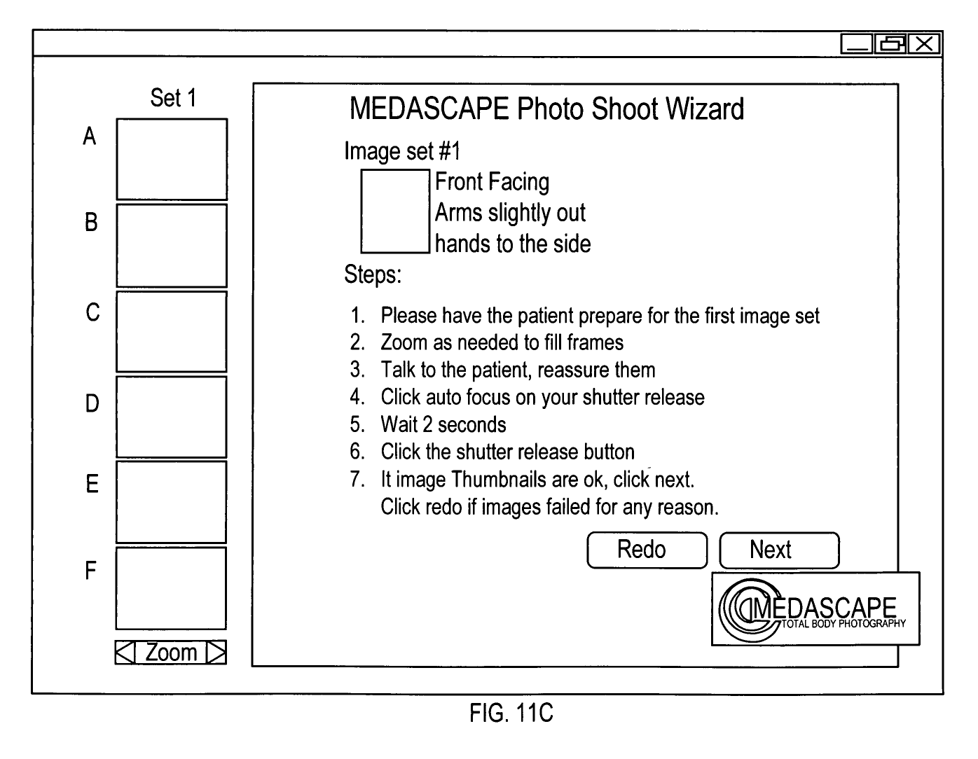

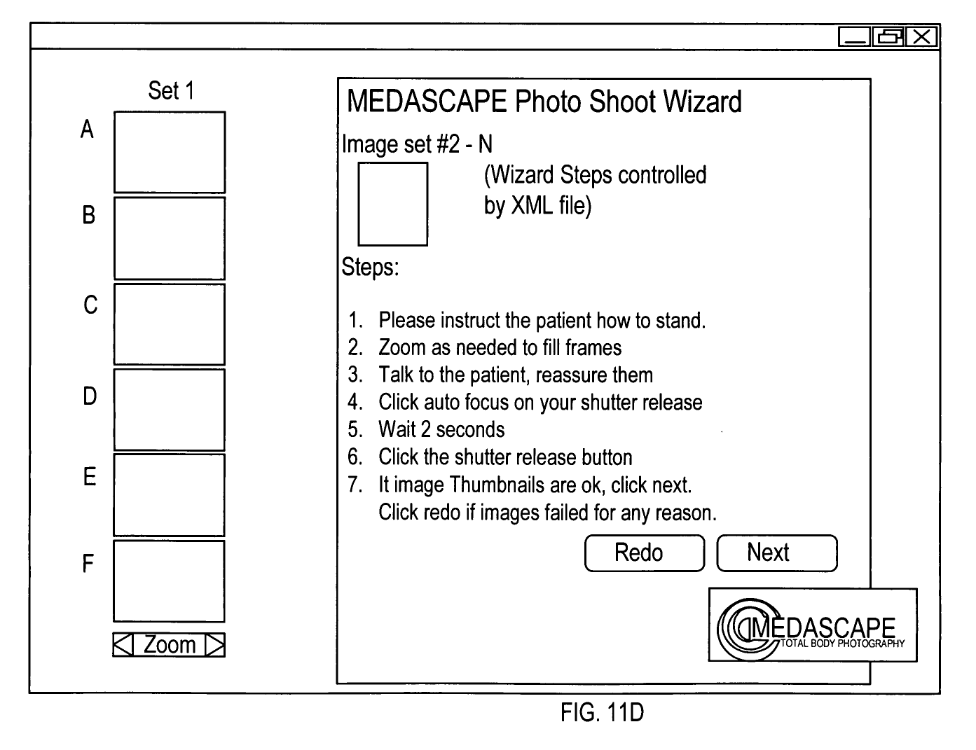

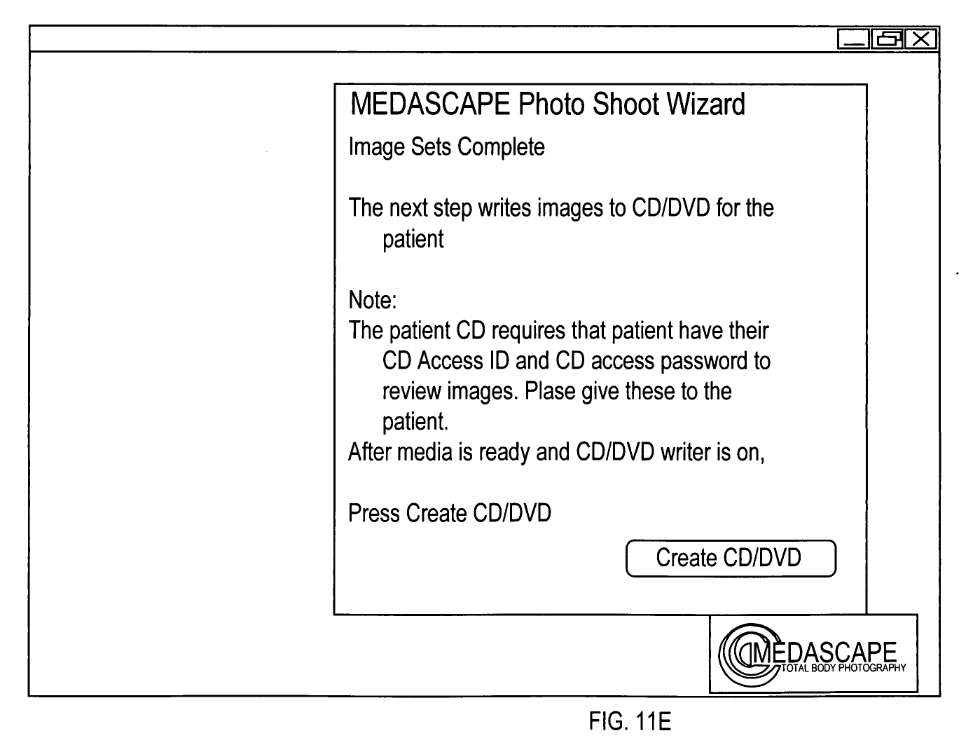

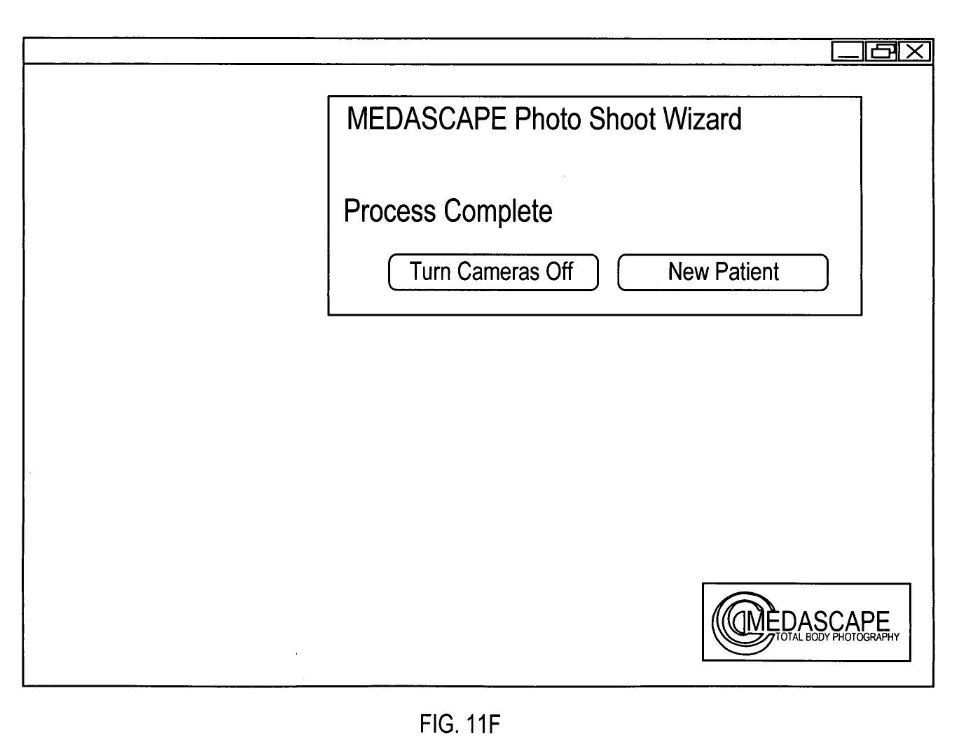

FIGS. 11A, 11B, 11C, 11D, 11E, and 11F show the screen shots for the operator running through the main steps 200 previously described in reference to FIGS. 7 and 7A-7D, starting with gathering patient info, 210 FIG. 7A. FIGS. 11A-11F show the screen shots occurring during the Imaging process.

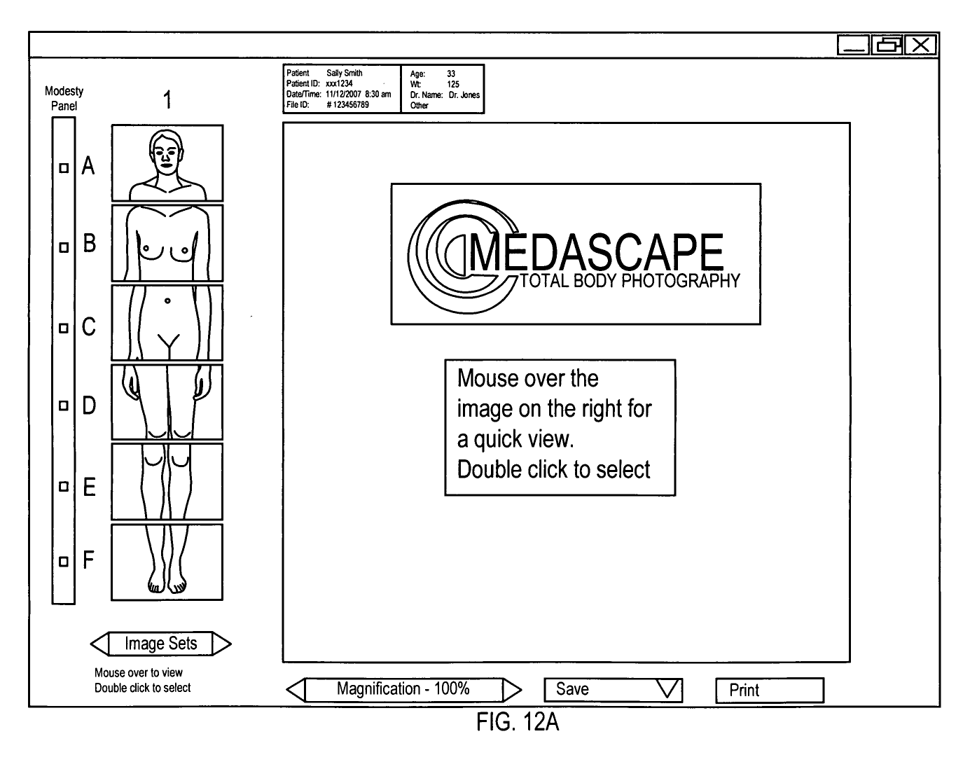

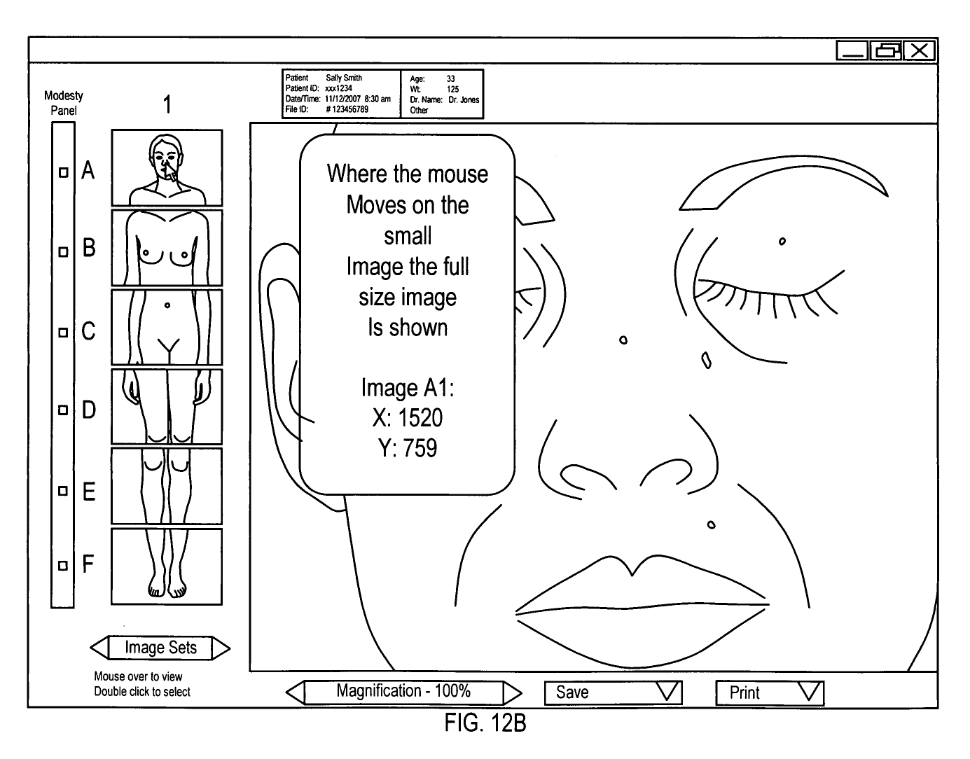

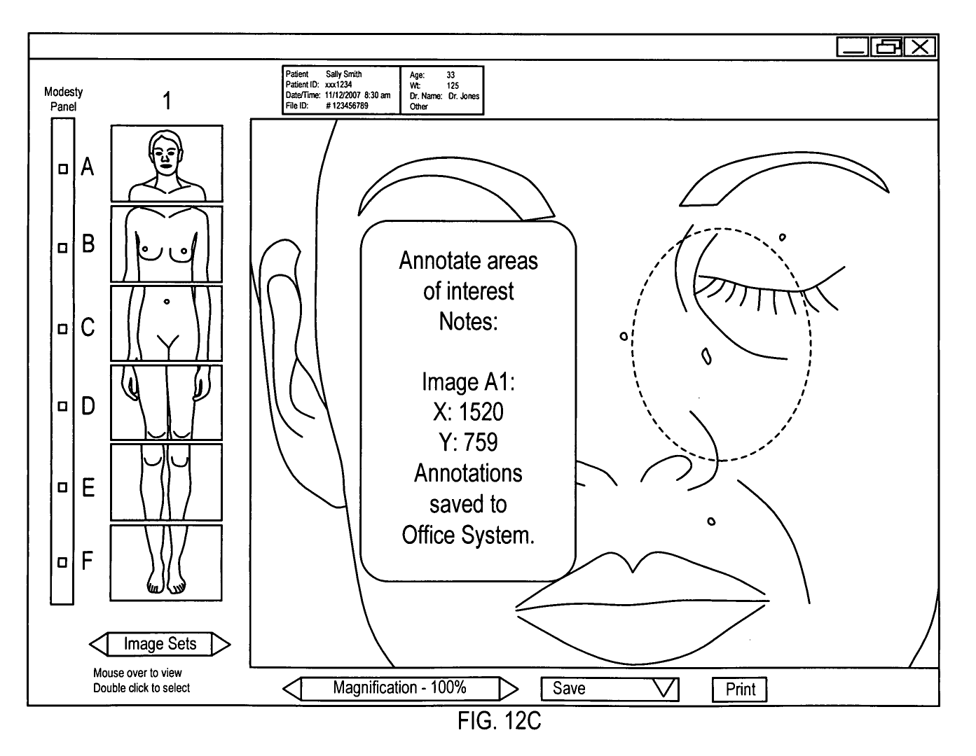

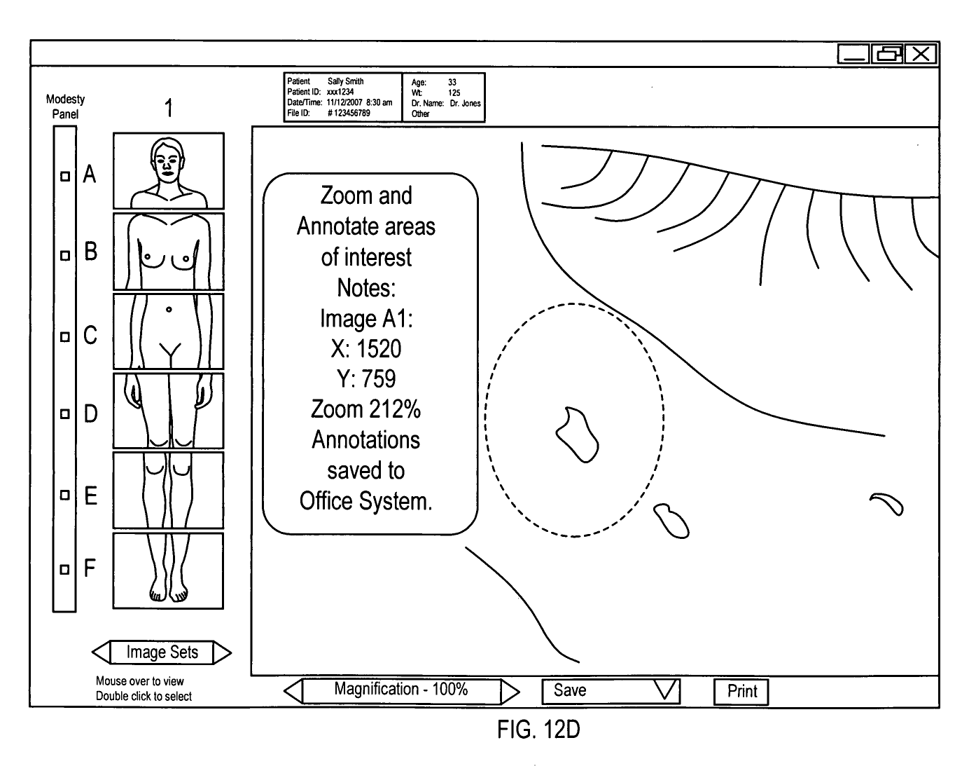

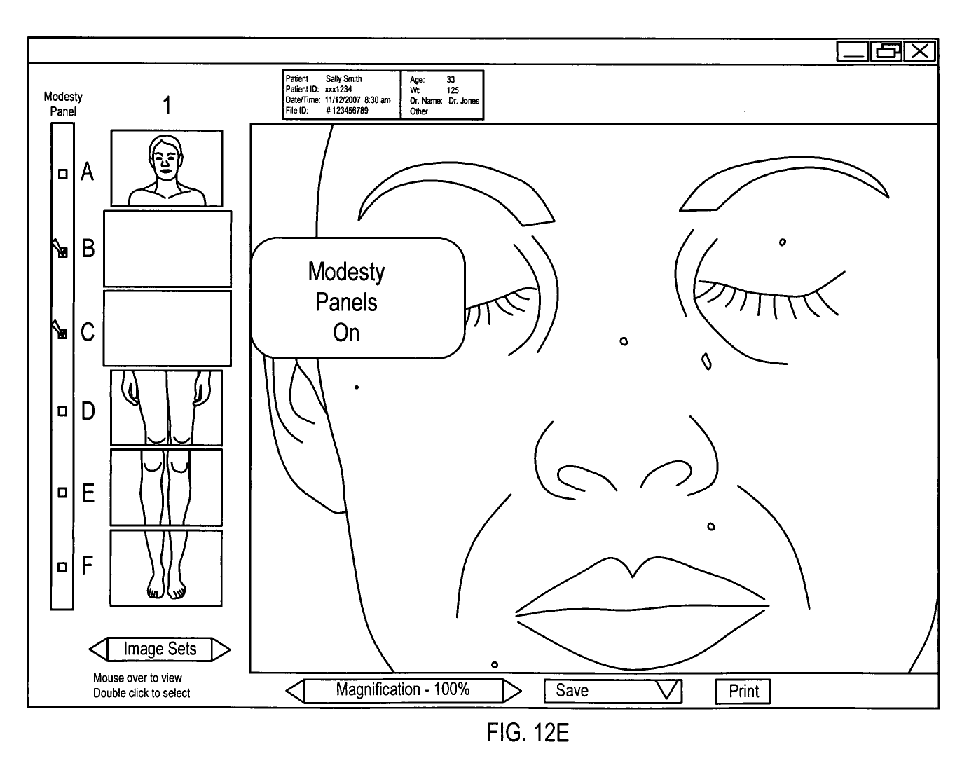

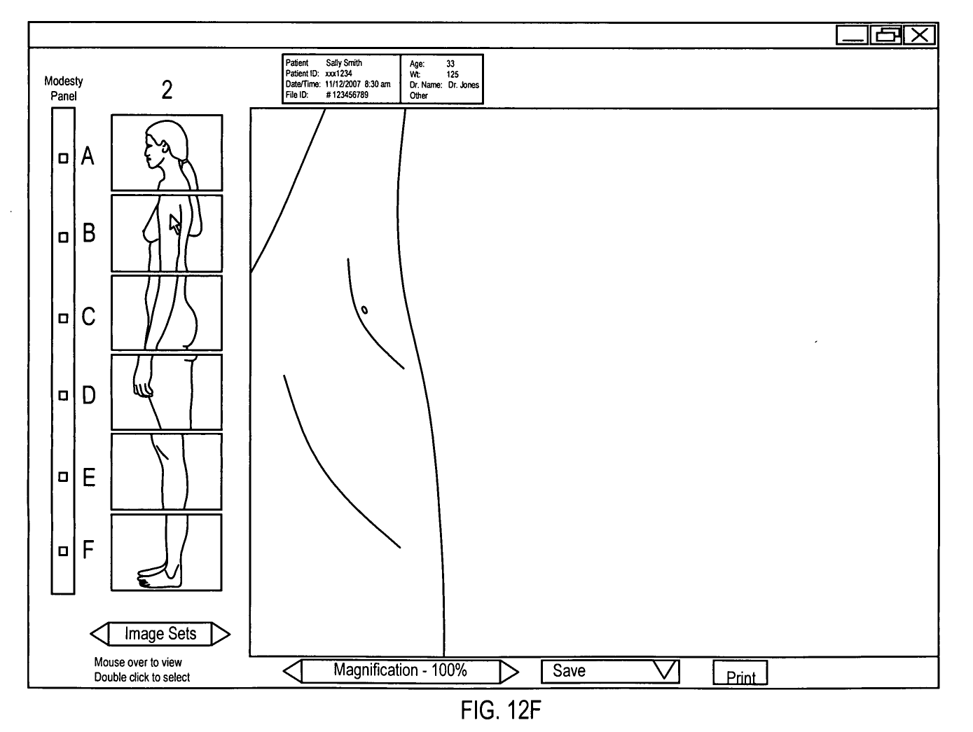

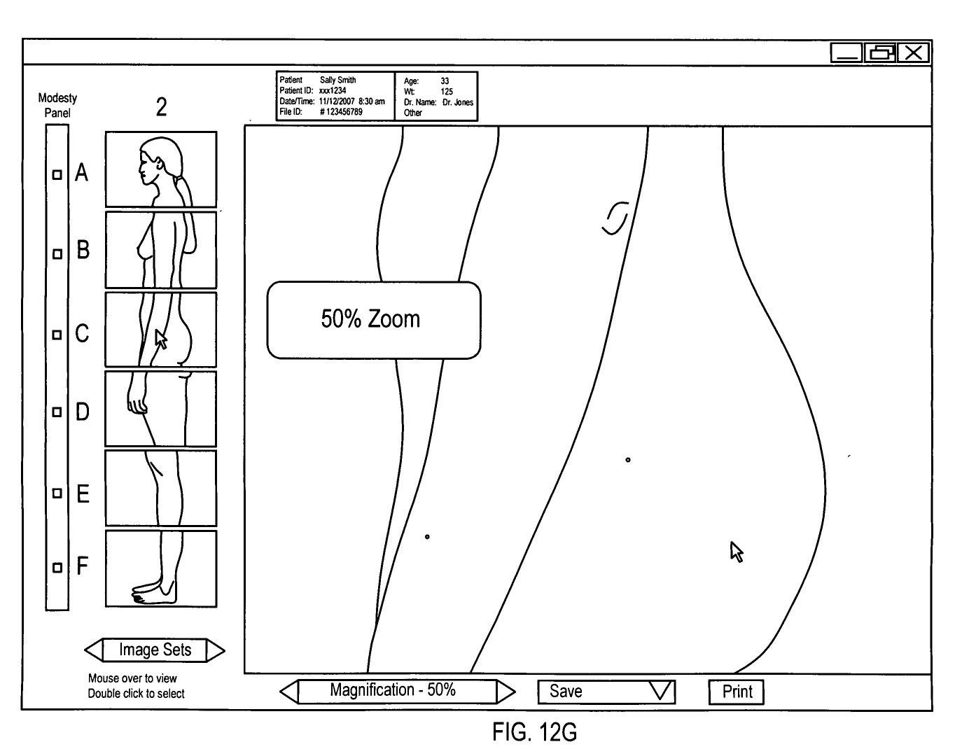

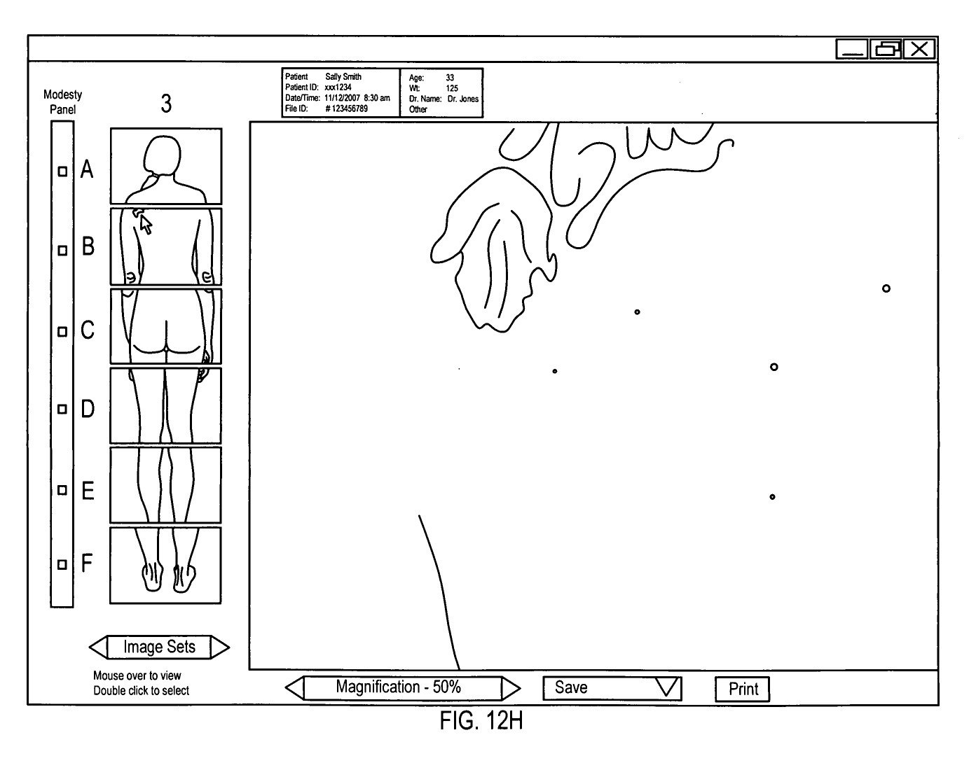

FIGS. 12A, 12B, 12C, 12D, 12E, 12F, 12G and 12H shows the screen shots for taking different image sets of the patient, 230 FIG. 7C. FIGS. 12A-12G show the screen shots at the time of viewing the images and creating information in the note area with the annotation area turned on.

The capturing of the images 220 FIG. 7B is further shown in FIGS. 13A-13L of a large patient (PT) can includes the steps of capturing pictures of:

front view with thumbs forward, FIG. 13A;

front view with palms facing forward, FIG. 13B;

front view with palms facing back, FIG. 13C;

front view under breasts, FIG. 13D;

front view of inside of right thigh, FIG. 13E; and

front view of inside of left thigh, FIG. 13F;

left view with left arm down, FIG. 13G;

left view with left arm up, FIG. 13H

back view with arms and legs down, FIG. 13I;

back view with arms up, FIG. 13J

back view with left foot up, FIG. 13K

back view with right foot up, FIG. 13L

right view with right arm down, FIG. 13M; and

right view with right arm up, FIG. 13N.

The capturing of the images 220 FIG. 7B is further shown in FIGS. 14A-14L of a smaller patient (PT) can includes the steps of capturing pictures of:

front view with thumbs forward, FIG. 14A;

front view with palms facing forward, FIG. 14B;

front view with palms facing back, FIG. 14C;

front view of inside of right thigh, FIG. 14D; and

front view of inside of left thigh, FIG. 14E;

left view with left arm down, FIG. 14F;

left view with left arm up, FIG. 14G

back view with arms and legs down, FIG. 14H;

back view with left foot up, FIG. 14I

back view with right foot up, FIG. 14J

right view with right arm down, FIG. 14K; and

right view with right arm up, FIG. 14L.

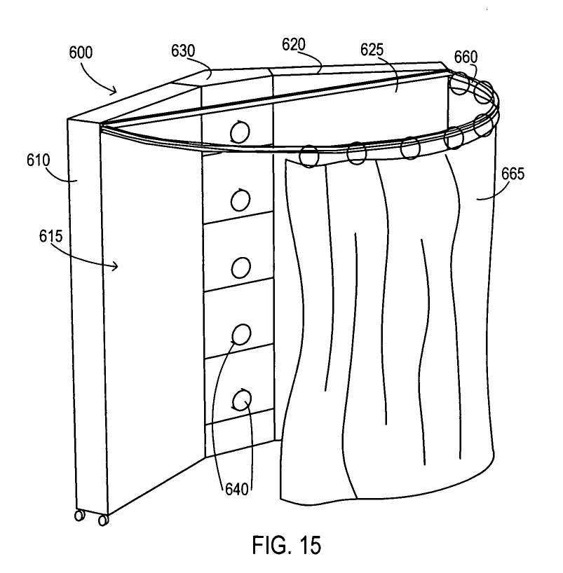

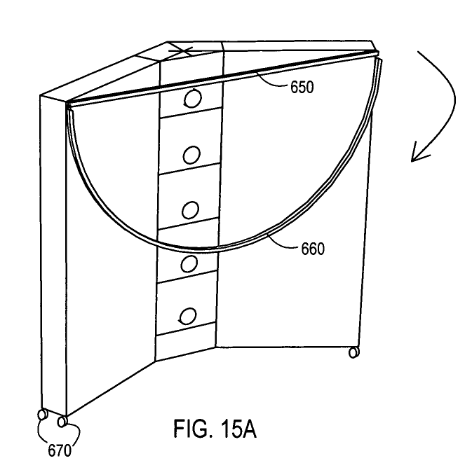

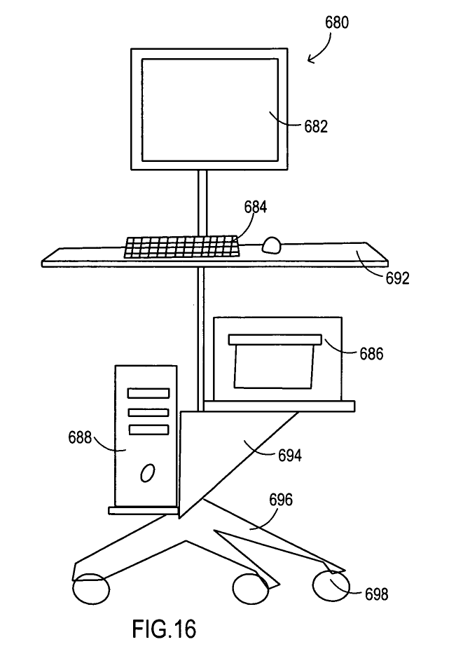

FIG. 15 shows a perspective view of another kiosk/booth enclosure 600 with fixed cameras 640 for where the patient physically rotates to different positions. FIG. 15A shows the kiosk/booth 600 of FIG. 15 without the current 665 and curtain rod 660 folded. FIG. 16 shows an operator station 680 for operating the cameras 640 and lights 615, 625 of FIGS. 15-15A.

Referring to FIGS. 15, 15A and 16, the kiosk/booth 600 can include a first angled wall 610 having an interior light panel 615 similar to the one described in reference to FIGS. 1A-6. The kiosk/booth 600 can include a second angled wall 620 with a similar interior light panel 625 and a middle tower section 630 between the angled walls 610, 620 with a support brace 650 holding the walls 610, 620 in a space apart configuration. The tower section 630 can have a stack of digital cameras 640 spaced equally apart from one another. A arc shaped curtain rod with ends attached to upper exterior end corners of the angled walls 610, 620 can fold out so that a privacy curtain 665 can be used to close off the space where patients can get their pictures taken. The kiosk/booth 600 can have wheels 670 under the walls 610, 620 so that the kiosk/booth 600 can be easily moved from place to place.

An operator station 680 can be used to operate the lights 615, 625 and cameras 640. The operator station 680 can include a monitor 682 with attached keyboard 684, and connected to a printer 686 and computer 688. The equipment can be supported by a tabletop 692, that is supported above a floor by support arms 694, and floor stand 696 that can have wheels 698 for allowing the operator station to be mobile.

Referring to FIGS. 15, 15A and 16, the operator station 680 can be used to allow for the five cameras 640 to equally take pictures of one standing patient. The patient can move in perpendicular directions in front of the cameras 640 so that a total of four clicks will allow for 20 pictures to be taken. The novel setup allows for the five cameras to take 20 pictures where all the picture sets are uniformly taken, and there is no need or requirement for setting up the cameras 640 since they are pre-located. The vertical stack of cameras can include as little as two and up to six more cameras in a stacked arrangement. Two cameras can allow for eight pictures to take all four orthogonal planar views of the patient. Six cameras can allow for twenty four pictures to take all four orthogonal planar views of the patient.

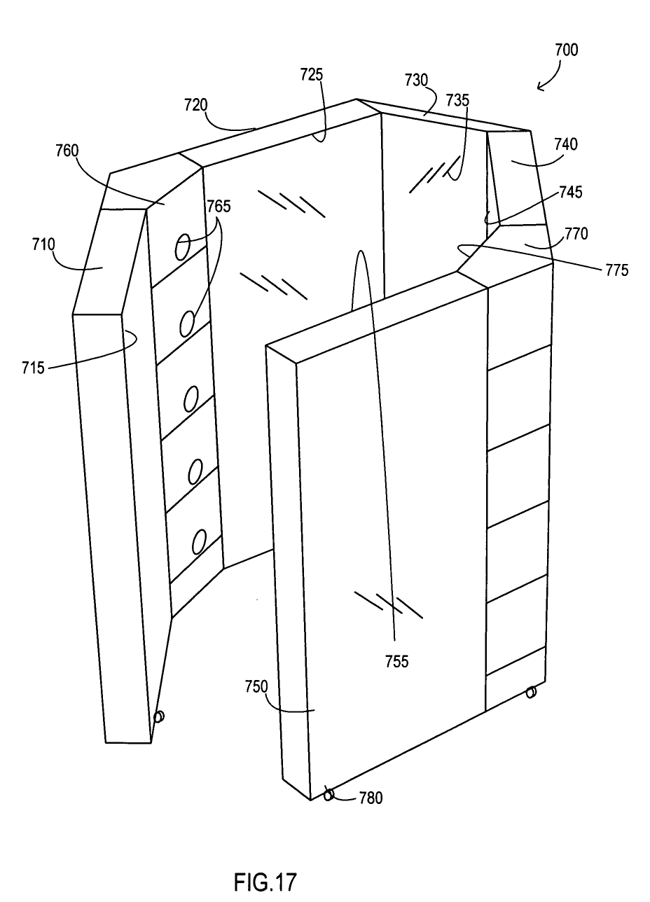

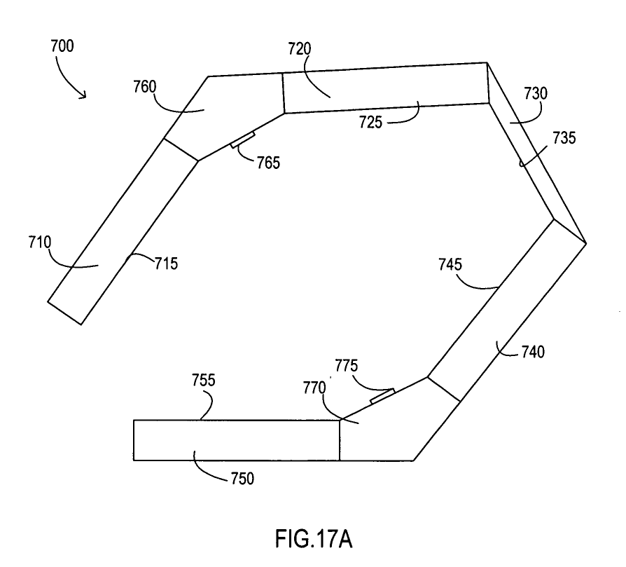

FIG. 17 shows a perspective view of another kiosk/booth enclosure 700 with two columns 760, 770 of fixed cameras 765, 775 for taking pictures of a patient. FIG. 17A is a top view of the kiosk/booth 700 of FIG. 17.

Referring to FIGS. 17-17A, another embodiment of the fixed kiosk/booth 700 can include a first angled wall 710 with an interior facing first light panel 715 attached to one side to a first tower 760 having a five stacked digital type cameras 765, the tower being attached to a second angled wall 720 with interior facing second light panel 625. The side of the second angled wall 720 being attached to a third angled wall 730 with interior facing third light panel 735, with a fourth angled wall 740 with interior facing fourth light panel 745. A second tower 770 having a vertical stack of digital cameras 775 can be attached between the fourth angled wall 740 and a fifth angled wall 750, the latter having an interior facing fifth light panel 755. Having a second tower can allow for the patient to only have to turn in a perpendicular direction once so that two orientations of the patient will allow for all four orthogonal planar views of the patient to be captured. Thus, using five cameras in each tower will allow for only having to click activate the cameras twice to capture some twenty pictures of the patient. Having two vertical stacks of cameras reduces the amount of click activations of having to take pictures with one stack in half. The two vertical stacks of cameras can be operated simultaneously so that all cameras in the vertical stacks take pictures at one time. Also, the vertical stacks of cameras can be operated sequentially (one stack after the other).

The kiosk/booth 700 can have an overall C-shaped configuration where a patient can enter in a narrow space opening between the first angled wall 710 and the second angled wall 750. The kiosk/booth 700 can also have wheels 780 to allow for mobility. The operator station 600 previously described can be used to operate both vertical stacked cameras 765, 775 simultaneously or sequentially. A patient can stand in two positions perpendicular to one another where only two clicks are necessary to take some twenty pictures of the body.

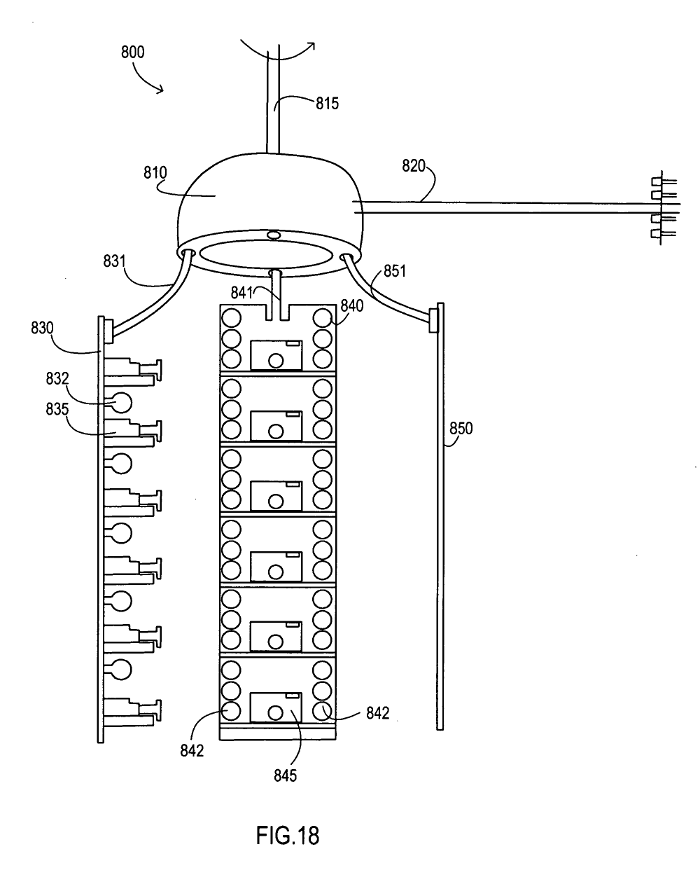

FIG. 18 is a partial view of a rotatable pod stand 800. the rotatable pod 800 can be attached by a support rod to a rotatable motor (not shown), where the entire stand can be positioned within a curtained booth (not shown). The pod can have an upper cap 810 that is attached by power/communication links 820 to an operator station 600 previously described. The pod 800 can have vertical wall panels 830, 840, 850 held in place by support arms 831, 841, 851 to the upper cap 810. The panels can have cameras 835, 845, with individual lights 832, 842 such as but not limited to light emitting diodes (LEDs). The patient can be instructed to stand still while the pod 800 is rotated about the patient, and the operator can use the operator station 600 to gather images.

The novel invention can be used to provide benchmark photography for identifying and tracking existing skin conditions and future changes. The invention can be used for tracking changes in moles, tattoo, scars and other skin conditions over time is made possible by high-resolution, color-balanced, benchmark photography.

The invention is an integrated solution combining hardware and software for the capture of such images, documenting conditions, archiving them and retrieving them for further review, comparisons or to document updates.

As a medical imaging appliance the kiosk/booth contain cameras, lighting, computer station, and privacy curtains/background screens that allows the subject (patient) to have optimum positions for the capture sessions. In the different embodiments one or more cameras can be positioned vertically or can be positioned up to 360 degrees to capture images of the entire body.

The control software allows for an operator and the subject an easy-to-use step-by-step imaging process. The Operator enters subject profile information and can be further expanded to instruct the subject on a number of poses if needed. Once the subject is in position, the operator clicks a button at which point the wizard takes a photo set and automatically advances to the next set of instructions.

The software and controls allows for instructions for multiple image set based on the criteria required by the operator/user. An image set contains high-resolution digital photos creating a final image session library of up to 200 digital images. The number of digital photos in an image session library can go up or down depending on the needs of the user. The computer can archives images which can be later written to a CD/DVD or emailed. The archive can also be referenced in a subject library locally on a PC or larger server configuration for individual. The archived images can have shared access locally or over the internet. Additional features can include skin tone adjustments, zoom, and support for additional special purpose image scripts.

The image viewer allows for viewing and annotating of captured images. This can be a Microsoft Windows application designed for Laptop or Tablet PC computers that may be used by the user to document as a narrative or via pre programmed pre determined selections an audit or profile of a partial of all skin anomalies, conditions, moles, tattoo, scars, distinguishing marks, and the like.

All of this documentation can be appended to each subject's image session of photos. Each subject's photo session is saved and archived in a subject directory.

Image Search Engine

The system can use a search engine that can seek out by keyword and produce results that match criteria entered by the user. The search engine can search through either locally, server based, internet, wide area network and so on an unlimited number of subjects image sessions and documentation stored onto the system that they have access to. Note there can be different search engines seeking different profiles based on user access rights.

The user can enter name of the subject to access results of those that match that criteria. However, the unique application of the search engine can allow users to search by specified or distinguishing skin characteristics. Additionally, digital images can also be referenced by distinguishing characteristics based on an optional area of the body to further narrow down specifically as to what subject closely matches that criteria when results are reported to the user.

Image Search Engine Example:

A user can enter a search query as follows: “Please provide moles on necks of white females under 6 ft tall.” The system will allow for multiple search words to identify who in the database matches the criteria. OR—Request All persons that have a unique tattoo, scar or mark on a particular area of the body.

The search engine can seek out the requested criteria using information already previously documented as to the identifying characteristics of the subject when the initial and subsequent image sessions have been taken. At the time of any image session the user, operator or third party must detail and document and profile of all skin condition and register them into the search engine database to enable the search to successfully retrieve those subjects that fit within the requested criteria.

The system can also contain image recognition software which provides that a picture or hand drawing of an identifying characteristics may be created or scanned into the system and can order a search of subjects that can have that mark on their body without the need for keywords.

Image Admin Web Site

An administration website can be used to receive image session data via web services from each installed Imaging Pod for billing or other informative data as the case can be. Image session information can be transmitted each time a photo session takes place if there is an Internet connection.

This website can be made secure to be only accessible by authorized staff or contractors. Role based security is enabled and supported by SSL encryption. This site can also be used for inventory management and support of end users.

### Process Flow

The heart of the imaging system component is the integration of cameras and software to benchmark consistent photos. The simplicity and power of the imaging systems makes this possible.

The design includes numerous XML flies that control the process and allow for future flexibility.

### Creation of Image Session Wizard

Completed by trained authorized staff
Edit or create new Image Session (XML File)
   Control fields for:
      Header and Instruction Text
      Patient Position Script
      Lights on or off
      Button controls for previous/next/take photo
Current default wizard is a multiple image set
Editing is currently done in the raw XML file—future versions may also provide a user interface.
Facilitates the user to document descriptions or profiles of images captured from the body
Facilitates and insures an interface for the user to access the search engine.

### Setup—Computer and Users

Update operating system patches
Other installs per current setup specs
Configure User Roles
   Image Operator
   Archive Operator
   Admin
   Remote Access
   Annotation
   Search Engine Operator

### Setup—MIW

Completed by trained Medascape staff
Install MIW
Update to current version of the MIW
Image Pod ID entered into system XML file
Connection strings entered into system XML file

### Setup—Admin Web Site

Completed by trained Medascape staff
Enter Facility, Venue, Office Information including POD ID
Enter Serial numbers of cameras, computers and other assets installed
Enter contact information for client, facility, venue, office.
Enter authorized users and roles for users.
Enter other information as needed by current policies

### Training—Medascape Medical Imaging System

Training is required for operators prior to use.

### The Image Viewer (MIV)

Two optional versions of the image viewer can be deployed. The subject's version if applicable requires the subject's username and password in order to access the images. The Facility, Client or Operator's version a separate password to access files or third party media such as CD/DVD's of the images.

Image viewing process

The image viewer displays one image set at a time, in thumbnail form; each set consists of multiple images. The viewer allows the user to navigate from one image set to the next, and back again.

The user may click on any thumbnail image to access the full-size image. By default, only a portion of the full-size image is displayed in the viewer. A “box” icon, which corresponds to the currently viewable portion of the full-size image, is displayed when the user's mouse is over the thumbnail. Clicking on the thumbnail will “lock” the full-size image in place, allowing the user to scroll the image with scroll bars, as well as enabling the Annotation Mode. While in this mode, the user may also zoom the full-size image in and out using either the keyboard (F8 and F9 keys), or by clicking on the Zoom In/Zoom Out buttons.

### Annotation Process

Once an image has been “locked,” the Annotate Image button will be enabled, and the color-picker box will become visible. Clicking the button will allow the user to click and drag shapes (in the currently selected color) on the visible portion of the full-size image. Once an oval has been created, a box pops up which prompts for a legend designation (20 characters) and a description (255 characters) or a pre programmed pull down of selection/identifier descriptions or definitions for each part of the body the user wishes to recognize, flag, highlight, feature and so on. The legend is displayed on the full-size image, directly above the annotation oval.

All annotations are loaded into the corresponding search engine and cataloged in a subject directory for later retrieval as a stand alone or request or part of a general search for subjects that have similar characteristics as defined by the subjects post image annotation.

The user can edit and/or delete existing annotations by clicking on the ovals. If the user clicks the “Save Image As . . . ” button while in Annotation Mode, the resulting PNG file will have the annotations saved on it. The description for each annotation will be shown on the bottom portion of the image, along with the legend designation. When the “Annotation Off” button is clicked, the annotations are saved locally to an XML file, and are then hidden from view. An icon indicating that annotations exist for that image appears next to the thumbnail image.

While the invention references activating all the cameras in a single stack with one activation, the invention can allow for selected cameras in the stacks to take pictures one at a time as selected by the operator. For example, the operator, can separately request one of the stacked cameras take extra shots. Additionally, the cameras can be operated to zoom in and enlarge selected picture shots as needed.

While the invention references medical applications for use with dermatologists to examine skin anomalies, the invention can have other applications such as but limited to law enforcement. For example, the invention can share platforms with different law enforcement agencies such as but not limited to local and state police agencies and federal agencies. The invention can capture skin image features, and include the taking of other identification features such as tattoos, scars, and the like. Booking photo pictures of arrested persons can be taken with the novel invention as well as release photo pictures can be taken since many prisoners have different skin features such as tattoos after being incarcerated. The invention can be used to categorize and correctly identify prisoners that have added tattoos, scars and other skin appearing features over time. National databases can use the captured images to aid in identifying persons down the road during arrests and the like.

Medical examiners can access the database for identifying the departed when there are questions about correct identifications. Screening applications can be used for identifying others such as suspected criminals, illegal aliens, child molesters, missing children, security personal and the like.

The invention can also be used and/or incorporated with other types of exterior detection and examination techniques such as but not limited to facial imaging, eye imaging, fingerprints, and the like.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A method of imaging all skin surfaces of a body, comprising the steps of:
gathering and entering identification information on a patient into a computer;
capturing front, left and right sides and back pictures of the patient with a vertical stack of multiple cameras;
gathering the pictures into digital images;
viewing organized and selected versions of the digital images.

2. The method of claim 1, wherein the gathering and entering identification information step includes the steps of:
inputting name, height, weight, gender and patient social security number and password.

3. The method of claim 1, wherein the capturing step includes the step of:
capturing front pictures of the patient with the vertical stack of digital cameras;
capturing left side pictures of the patient with the digital cameras;
capturing back pictures of the patient with the digital cameras; and
capturing right side pictures of the patient with the digital cameras.

4. The method of claim 1, where the gathering the pictures step includes the steps of:
Compiling the images;
Processing the images;
Creating object VR images;
Sending image session to server;
Writing a CD or a DVD of the images; and
Readying for another patient.

5. The method of claim 1, wherein the viewing step includes the steps of:
Organizing digital film strips for each pose; and
Zooming and scrolling portions of the images.

6. The method of claim 3, wherein the capturing of the images includes the steps of capturing pictures of:
front view with thumbs forward;
front view with palms facing forward;
front view with palms facing back;
front view under breasts;
front view of inside of right thigh; and
front view of inside of left thigh.

7. The method of claim 3, wherein the capturing of the images includes the steps of capturing pictures of:
left view with left arm down; and
left view with left arm up.

8. The method of claim 3, wherein the capturing of the images includes the steps of capturing pictures of:
back view with arms and legs down;
back view with arms up;
back view with left foot up; and
back view with right foot up.

9. The method of claim 3, wherein the capturing of the images includes the steps of capturing pictures of:
right view with right arm down; and
right view with right arm up.

10. The method of claim 3, wherein the capturing step includes:
providing at least five digital cameras as a single stack of the cameras;
click activating all the cameras in the single stack simultaneously so that a complete front view of the patient is taken with the single stack of cameras; and
repeating the click activating step so that all four orthogonal planar views of the patient are taken with the single stack of cameras from a total of only four click activations of the stacked cameras.

11. The method of claim 10, further comprising the step of:
orienting the patient to physically move from the front view to the left side view to the back view to the right side view in front of the single stack of the digital cameras so that a total of four click activations will result in at least twenty pictures being taken.

12. The method of claim 3, further comprising the steps of:
providing a second stack of at least five digital cameras, that are facing the first stack of the at least five digital cameras;
click activating all the cameras in the first stack of digital cameras simultaneously so that the front view of the patient is taken;
click activating all the cameras in the second stack of digital cameras so that the back view of the patient is taken; and
repeating the above so that all four orthogonal planar views of the patient are taken with only two click activations of the first and second stacked cameras.

13. The method of claim 12, further comprising the step of:
orienting the patient to physically turn perpendicular in front of the first and the second stacks of digital cameras so that a total of two click activations will result in at least twenty pictures being taken.

14. A total body imaging system, comprising:
a mobile booth enclosure having an entranceway, and side walls and, a rear wall closing the enclosure or a privacy curtain; and
a vertical stack of digital cameras, wherein front, left side, right side and rear of a patient is imaged with simultaneous activation of the vertical stack of the digital cameras, the vertical stack of cameras including between two to six cameras in the vertical stack.

15. The total body imaging system of claim 14, wherein the enclosure includes:
walls that are slideable with one another so that the enclosure is collapsible.

16. The total body imaging system of claim 14, further comprising:
a touch screen computer for allowing an operator to enter patient data, take digital pictures, and compile and process the pictures for viewing selected pictures.

17. The total body imaging system of claim 14, wherein the single tower includes:
at least five digital cameras; and
a single control for simultaneously activating the at least five digital cameras so that physically turning the patient from the front to the left side to the rear and to the right side allows for all orthogonal planar views of patient to be imaged with only four activations of the single control.

18. The total body imaging system of claim 14, wherein the single tower includes:
a first single tower of at least five digital cameras;
a second single tower of at least five digital cameras, the second single tower facing the first single tower; and
a control for simultaneously activating all the cameras in the first single tower and all the cameras in the second single tower so that physically turning the patient once in a perpendicular direction allows for all orthogonal planar views of patient to be imaged with only two activations of the control.

19. The total body imaging system of claim 14, wherein the vertical stack of digital cameras includes:
left angled light panel on a left side of the vertical stack of cameras; and
right angled light panel on a right side of the vertical stack of cameras.

20. The total body imaging system of claim 14, further comprising:
left top strobe mounted on top of the left angled light panel;
left bottom strobe mounted on a bottom of the left angled light panel;
right top strobe mounted on top of the right angled light panel; and
right bottom strobe mounted on bottom of the right angled light panel.
